(19) United States
(12) Patent Application Publication
(10) Pub. No.: US 2026/0252960 A1
(43) Pub. Date: Aug. 27, 2026

(54) SYSTEM

(71) Applicant: SoftBank Group Corp., Tokyo (JP)

(72) Inventor: Tomokazu YONESU, Tokyo (JP)

(73) Assignee: SoftBank Group Corp., Tokyo (JP)

(21) Appl. No.: 19/536,272

(22) Filed: Feb. 11, 2026

(30) Foreign Application Priority Data
Feb. 21, 2025 (JP) 2025-027036

(51) Int. Cl. G06N 20/00; G06F 40/30; G06N 3/08

(52) U.S. Cl. CPC G06N 20/00; G06F 40/30; G06N 3/08

(57) ABSTRACT

The system according to the embodiment comprises a summarization unit, an answering unit, and a voice generation unit. The summarization unit analyzes the content of an article, extracts important points, and generates a summary. The answering unit answers a user's question based on the summary generated by the summarization unit. The voice generation unit converts the article into speech based on the answer generated by the answering unit.

### CROSS-REFERENCE TO RELATED APPLICATION

The present application claims priority to and incorporates by reference the entire contents of Japanese Patent Application No. 2025-027036 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, news articles are uniformly distributed as text only, and there has been a problem that customization according to the user's situation is difficult.

### SUMMARY OF THE INVENTION

The system according to the embodiment comprises a summarization unit, an answering unit, and a voice generation unit. The summarization unit analyzes the content of an article, extracts important points, and generates a summary. The answering unit answers a user's question based on the summary generated by the summarization unit. The voice generation unit converts the article into speech based on the answer generated by the answering unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

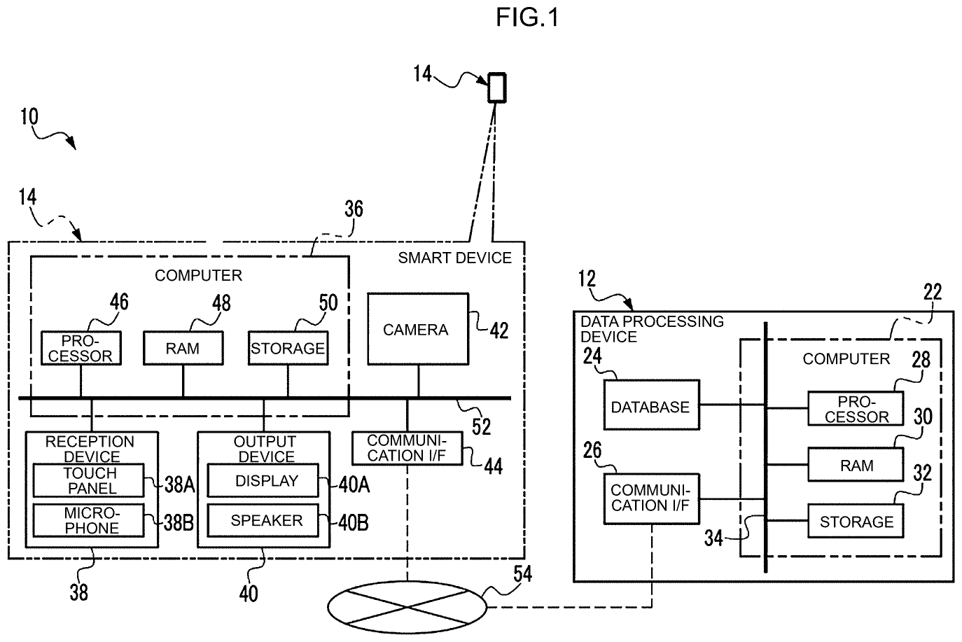

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

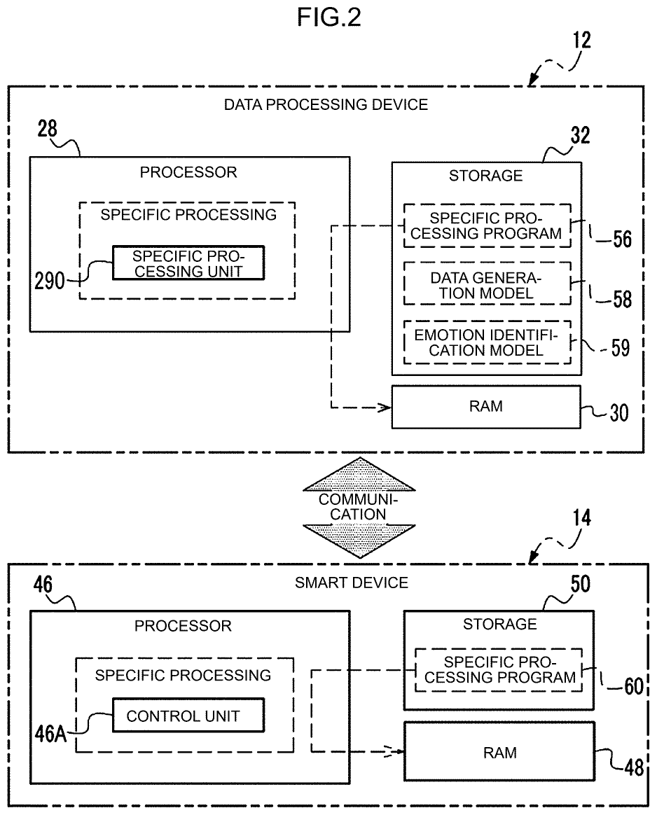

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The news customization system according to the embodiment of the present invention is a system that not only uniformly distributes news articles as text, but also allows one-touch customization according to each user's situation. This news customization system comprises a summarization unit configured to analyze the content of an article, extract important points, and generate a summary; an answering unit configured to answer a user's question based on the summary generated by the summarization unit; and a voice generation unit configured to convert the article into speech based on the answer generated by the answering unit. For example, the news customization system uses generative AI to analyze the content of an article, extract important points, and generate a summary. Next, when a user inputs a question about the article, the generative AI generates an answer based on the content of the article. Furthermore, the generative AI analyzes the content of the article and reads it aloud in natural speech. The news customization system collects user reports of clickbait headline articles, and if there are multiple reports, it automatically optimizes the headline. In addition, by analyzing the content of the article using generative AI and performing translation and speech conversion, batch conversion and speech generation of foreign articles is enabled. As a result, users can customize news articles according to their own situation and efficiently obtain information. Thus, the news customization system can customize news articles according to the user's situation and efficiently provide information. Specifically, this news customization system, by linking multiple AI modules, realizes optimized information provision for each user, which is different from conventional simple text distribution systems. The summarization unit, for example, uses a Transformer-based large language model and receives as input a token sequence of the article body (e.g., a Japanese text array of up to 4096 tokens). Examples of input include news articles such as “A new AI technology was announced at the international conference in June 2024” or “The Meteorological Agency predicts a heat wave this summer.” The summarization unit extracts contextually important words and phrases using a self-attention mechanism and generates a summary sentence as output (e.g., “New AI technology announced at international conference,” “Heat wave expected this summer,” etc.). Next, the answering unit receives as input a user's natural language question (e.g., “What are the features of this AI technology?” “What are the countermeasures for the heat wave?”) and, using the output summary from the summarization unit and the original article body as context, the generative AI generates an answer sentence (e.g., “The new technology has twice the inference speed compared to conventional technology,” “Use air conditioning and stay hydrated are recommended,” etc.). The answering unit uses a BERT-series encoder for semantic analysis of the question and calculates semantic relevance with the article summary to generate the optimal answer sentence. The voice generation unit receives the output text from the answering unit as input and generates a natural speech waveform (e.g., 16 kHz, 16 bit PCM data) using deep neural network-based speech synthesis models such as WaveNet or Tacotron2. The voice generation unit can also automatically adjust the bitrate and playback speed of the speech according to the user's device type and network bandwidth. For the clickbait headline reporting function, users can send feedback such as “This headline is misleading” by button operation, and the reporting unit records this in a database and, when the number of reports exceeds a certain threshold, automatically executes a headline correction algorithm (e.g., sentence splitting, detection of exaggerated expressions, generation of correction candidates). For the batch translation and speech generation function for foreign articles, the translation unit uses a Transformer-type neural machine translation model to translate multilingual articles such as English or Chinese into Japanese, and then the voice generation unit generates Japanese speech. Examples of AI input include text arrays of English articles, user questions, facial images or speech waveform data for user emotion estimation, etc. Examples of AI output include summary sentences, answer sentences, translation sentences, speech waveform data, headline correction proposals, etc. These outputs are used for subsequent user interface display, speech playback, article database updates, push notifications to users, and other processing. As a technical effect, this system automates high-precision summarization, answering, speech generation, translation, and headline optimization by AI, thereby realizing optimal information provision for each user quickly and with low load, and greatly improving information acquisition efficiency, user satisfaction, and system operation cost compared to conventional manual editing or simple automatic distribution. Specific application fields include news distribution services, educational information provision, intra-company information sharing, multilingual information transmission during disasters, and voice news provision for visually impaired persons.

The news customization system according to the embodiment comprises a summarization unit, an answering unit, and a voice generation unit. The summarization unit analyzes the content of an article, extracts important points, and generates a summary. For example, the summarization unit uses generative AI to analyze the content of an article, extract important points, and generate a summary. The generative AI uses a text generation AI (for example, LLM) to concisely summarize the article. In addition, the summarization unit can use multimodal generative AI to summarize the content of the article. For example, the generative AI uses keyword extraction technology to pick up particularly important information in the article and generates a summary based on it. The answering unit answers a user's question based on the summary generated by the summarization unit. For example, the answering unit uses generative AI to generate an appropriate answer to the user's question. The generative AI uses natural language processing technology to analyze the user's question and generate an answer based on the content of the article. The voice generation unit converts the article into speech based on the answer generated by the answering unit. For example, the voice generation unit uses generative AI to analyze the content of the article and read it aloud in natural speech. The generative AI uses speech synthesis technology to convert the content of the article into speech. As a result, the news customization system can efficiently perform article summarization, answering questions, and speech generation. Specifically, this news customization system is equipped with a Transformer-based large language model as the summarization unit, which receives as input a token sequence of the article body (e.g., a Japanese text array of up to 4096 tokens). The summarization unit uses a self-attention mechanism to extract contextually important words and phrases and generates a summary sentence as output (e.g., “New AI technology announced at international conference,” etc.). As a multimodal generative AI, the summarization unit can also accept non-text information such as images and facial expression data as input. For example, the content of photos or charts attached to the article is vectorized by an image encoder (e.g., ResNet or Vision Transformer) and integrated with text information to be reflected in summary generation. Examples of AI input include news article body such as “A new AI technology was announced at the international conference in June 2024,” attached image pixel array (224×224×3), and article metadata (publication date, category, etc.). Examples of AI output include summary sentences (“New AI technology announced at international conference”), important keyword lists (“AI technology,” “international conference”), and summary scores (0.92), etc. The answering unit receives as input a user's natural language question (e.g., “What are the features of this AI technology?”) and, using the output summary from the summarization unit and the original article body as context, performs semantic analysis of the question using a BERT-series encoder, calculates semantic relevance with the article summary, and generates the optimal answer sentence (“The new technology has twice the inference speed compared to conventional technology,” etc.). Examples of AI input include question sentences (“What are the countermeasures for the heat wave?”), summary sentences, and article body, and examples of AI output include answer sentences (“Use air conditioning and stay hydrated are recommended”), answer confidence scores (0.87), etc. The voice generation unit receives the output text from the answering unit as input and generates a natural speech waveform (e.g., 16 kHz, 16 bit PCM data) using deep neural network-based speech synthesis models such as WaveNet or Tacotron2. The voice generation unit can also automatically adjust the bitrate and playback speed of the speech according to the user's device type and network bandwidth. Examples of AI input include text data (“Use air conditioning and stay hydrated are recommended”), desired speech tone by the user (“calm voice”), etc., and examples of AI output include speech waveform data, speech length (seconds), speech quality score, etc. These outputs are used for subsequent user interface display, speech playback, article database updates, push notifications to users, and other processing. As a technical effect, this system automates high-precision summarization, answering, and speech generation by AI, thereby realizing optimal information provision for each user quickly and with low load, and greatly improving information acquisition efficiency, user satisfaction, and system operation cost compared to conventional manual editing or simple automatic distribution. Specific application fields include news distribution services, educational information provision, intra-company information sharing, multilingual information transmission during disasters, and voice news provision for visually impaired persons.

The news customization system comprises a reporting unit configured to report clickbait headline articles. The reporting unit provides a function for users to report clickbait headline articles. For example, the reporting unit provides an interface for users to report clickbait headline articles. Users can click a report button to report clickbait headline articles. The reporting unit collects user reports and stores them in a database. As a result, the news customization system enables reporting of clickbait headline articles. Specifically, in the user interface section of this news customization system, dedicated buttons and input forms for reporting clickbait headline articles are dynamically generated so that users can intuitively perform reporting operations on the article viewing screen. When the reporting unit receives a user's reporting operation, it stores the reporting content (e.g., article ID, reason for reporting, user ID, reporting time, optional comments, etc.) as structured data in a temporary buffer and asynchronously transmits it to the server-side reporting database via a communication module. The reporting database supports both NoSQL and relational types, enabling fast aggregation, search, and duplicate elimination of reporting history. For subsequent AI processing, the reporting content can include natural language comments and selectable reasons (e.g., “exaggerated expression,” “factual error,” “inflammatory,” etc.). Examples of AI input include the reported article ID (integer value), reason for reporting (category label), user comment (text up to 512 tokens), reporting time (UNIX timestamp), etc. Examples of AI output include reporting content confidence score (0.0-1.0), duplicate report determination label (e.g., new/existing), reporting content cluster ID (similar report group), etc. These outputs are used for subsequent headline optimization processing, user notification, administrator review prioritization, and so on. As a technical effect, the reporting unit can collect and accumulate user feedback in real time and in a structured manner, greatly improving the accuracy and speed of headline quality management and automatic optimization processing for the entire system compared to conventional manual review or simple reporting functions. Specific application fields include headline quality management in news distribution services, countermeasures against misinformation in SNS and bulletin boards, reliability improvement of educational news materials, and content auditing in intra-company information sharing systems.

The reporting unit is configured to collect user reports and automatically optimize the headline if there are multiple reports. The reporting unit collects user reports and, if there are multiple reports, automatically optimizes the headline. For example, the reporting unit stores user reports in a database and counts the number of reports. If the number of reports exceeds a certain threshold, the reporting unit executes an algorithm to optimize the headline. For example, the reporting unit analyzes the content of the headline and corrects exaggerated or misleading expressions. As a result, the news customization system can optimize headlines based on multiple reports. Specifically, the reporting unit periodically aggregates the number of reports for each article accumulated in the reporting database, and when the number of reports for each article ID exceeds a predetermined threshold (e.g., 10, 20, etc.), it automatically triggers headline optimization processing. The headline optimization algorithm first inputs the headline text of the target article (e.g., up to 128 tokens) into a natural language processing AI, and a model for detecting exaggerated expressions (e.g., BERT-based classifier) assigns labels such as “exaggeration,” “factual error,” “inflammatory,” etc. Examples of AI input include headline text (“AI revolution changes the world!”), aggregated distribution of reporting reasons (“exaggeration: 8, error: 3”), and article body excerpt (up to 512 tokens). The AI calculates semantic consistency between the headline and the body and automatically extracts misleading expressions. Examples of output include candidate corrected headlines (“AI technology advancement announced”), reason for correction (“exaggerated expression removed”), and correction confidence score (0.91). As subsequent processing, candidate corrections are sent to administrator review or automatically reflected under certain conditions. As a technical effect, the reporting unit realizes automatic headline optimization by AI triggered by a large number of user reports, enabling fast and low-load maintenance of headline quality, prevention of misinformation spread, and improvement of user satisfaction compared to conventional manual headline correction or simple reporting functions. Application fields include automatic headline auditing in news distribution services, countermeasures against misinformation in SNS, quality management of educational news materials, and automatic auditing of intra-company information sharing.

The news customization system comprises a translation unit configured to collectively translate and convert foreign articles into speech. The translation unit provides a function to collectively translate and convert foreign articles into speech. For example, the translation unit uses generative AI to analyze the content of foreign articles and perform translation. The generative AI uses machine translation technology to translate foreign articles. The translation unit uses generative AI to convert the translated articles into speech. The generative AI uses speech synthesis technology to read the translated articles aloud in natural speech. As a result, the news customization system enables translation and speech conversion of foreign articles. Specifically, the translation unit is equipped with a Transformer-based neural machine translation model (e.g., encoder-decoder structure) and receives as input a text array of multilingual articles (e.g., English article body, up to 4096 tokens). The AI uses a pre-trained multilingual corpus to generate high-precision Japanese translations according to context. Examples of input include English article body (“A new AI technology was announced at the conference in June 2024.”), article title, article metadata (language, publication date, etc.). Examples of AI output include Japanese translation (“2024 [symbol] 6 [symbol] [symbol] AI [symbol] [symbol] ”), translation confidence score (0.95), number of tokens in the translation, etc. After translation, the voice generation unit inputs the translation into speech synthesis models such as WaveNet or Tacotron2 and generates speech waveform data in 16 kHz, 16 bit PCM format. The voice generation unit automatically adjusts speech parameters according to the user's device type and desired speech tone (e.g., male/female, calm/energetic, etc.). Examples of AI input for speech generation include translation text, speech tone specification, playback speed specification, etc., and examples of output include speech waveform data, speech length (seconds), speech quality score, etc. These outputs are used for speech playback in the user interface, saving to the article database, push notifications to users, and other processing. As a technical effect, the translation unit automates high-precision batch translation and speech conversion by AI, enabling immediate distribution of multilingual news, improved accessibility, and reduced operational costs compared to conventional manual translation or sequential speech conversion. Application fields include international news distribution, multilingual information transmission during disasters, voice news for visually impaired persons, and information sharing in global companies.

The translation unit is configured to analyze the content of an article using generative AI and perform translation and speech conversion. The translation unit analyzes the content of an article using generative AI and performs translation and speech conversion. For example, the translation unit uses generative AI to analyze the content of an article and perform translation. The generative AI uses machine translation technology to translate the article. The translation unit uses generative AI to convert the translated article into speech. The generative AI uses speech synthesis technology to read the translated article aloud in natural speech. As a result, by using generative AI, the accuracy of translation and speech conversion is improved. Specifically, the translation unit uses a Transformer-type neural machine translation model and receives as input a text array of multilingual articles (e.g., English, Chinese, Korean, etc., up to 4096 tokens). The AI extracts contextually important words and phrases using a self-attention mechanism and generates Japanese translations with semantic consistency. Examples of AI input include English article body (“The AI system achieved a breakthrough in June 2024.”), article title, article category (e.g., technology, economy, etc.). Examples of AI output include Japanese translation (“2024 [symbol] 6 [symbol] AI [symbol] [symbol] [symbol] [symbol] ”), translation confidence score (0.93), number of tokens in the translation, etc. After translation, the voice generation unit inputs the translation into speech synthesis models such as WaveNet or Tacotron2 and generates speech waveform data in 16 kHz, 16 bit PCM format. The voice generation unit receives parameters such as desired speech tone (e.g., calm voice, bright voice), playback speed, and volume from the user and dynamically adjusts the parameters of the speech synthesis model. Examples of AI input for speech generation include translation text, speech tone specification, playback speed specification, etc., and examples of output include speech waveform data, speech length (seconds), speech quality score, etc. These outputs are used for subsequent processing such as speech playback in the user interface, saving to the article database, and push notifications to users. As a technical effect, the translation unit automates high-precision translation and speech conversion by AI, greatly improving immediacy of information transmission, multilingual support, accessibility, and operational cost compared to conventional manual translation or sequential speech conversion. Application fields include international news distribution, multilingual information transmission during disasters, voice news for visually impaired persons, and information sharing in global companies.

The summarization unit is configured to estimate the user's emotion and adjust the expression method of the summary based on the estimated emotion. The summarization unit estimates the user's emotion and adjusts the expression method of the summary based on the estimated emotion. For example, the summarization unit uses an emotion engine or generative AI to estimate the user's emotion. The emotion engine analyzes data such as the user's facial expression or voice to estimate emotion. The generative AI adjusts the expression method of the summary based on the user's emotion. For example, if the user is feeling stressed, the summarization unit generates a summary using concise and positive expressions. If the user is relaxed, the summarization unit generates a detailed summary with a relaxed tone. Furthermore, if the user is in a hurry, the summarization unit generates a short summary emphasizing only the most important points. As a result, it is possible to adjust the expression method of the summary according to the user's emotion. Specifically, the summarization unit inputs facial images (e.g., 224×224×3 pixel RGB images), speech waveform data (e.g., 16 kHz, 16 bit PCM, 3 seconds), and user input text (e.g., up to 256 tokens) into an emotion recognition AI for emotion estimation. The emotion recognition AI uses CNN or RNN-based image and speech encoders to output emotion labels (e.g., stress, relaxation, hurry, etc.) and emotion intensity scores (0.0-1.0). Examples of AI input include a user's smiling image, speech waveform of a calm voice, and short comments (“I'm in a hurry,” etc.). Examples of AI output include emotion label (“stress”), emotion intensity (0.82), and estimation confidence (0.91). The summarization unit dynamically switches the decoder parameters and output templates of the summary generation AI (e.g., Transformer-based large language model) based on these emotion estimation results. For example, in case of stress, positive expressions are prioritized; in case of relaxation, detailed explanations are added; and in case of hurry, only key points are extracted. Examples of output include “New technology has been announced. Details will be provided later.” (in case of stress), “A new AI technology was announced at the international conference in June 2024, and inference speed has doubled.” (in case of relaxation), etc. These outputs are used for user interface display, input to the voice generation unit, saving to the article database, and so on. As a technical effect, the summarization unit automatically optimizes summary expressions according to the user's emotional state, greatly improving user experience, information transmission efficiency, and stress reduction compared to conventional uniform summary generation. Application fields include personalized news distribution services, educational information provision, information transmission support in medical and welfare fields, and voice news for visually impaired persons.

The summarization unit is configured to adjust the level of detail of the summary during summary generation based on the importance of the article. The summarization unit adjusts the level of detail of the summary during summary generation based on the importance of the article. For example, the summarization unit uses generative AI to evaluate the importance of the article. The generative AI analyzes data such as the number of views and the impact of the content to evaluate the importance of the article. The summarization unit adjusts the level of detail of the summary based on the importance of the article. For example, for highly important articles, the summarization unit generates a detailed summary. For articles of low importance, the summarization unit generates a concise summary. Furthermore, for articles of moderate importance, the summarization unit generates a summary with an appropriate level of detail. As a result, it is possible to adjust the level of detail of the summary according to the importance of the article. Specifically, the summarization unit uses a Transformer-based large language model and receives as input a token sequence of the article body (e.g., a Japanese text array of up to 4096 tokens), the number of views (integer value), the number of shares on SNS (integer value), the impact score of the article content (real value from 0.0 to 1.0), and article metadata such as category (e.g., politics, economy, entertainment, etc.). The summarization unit integrates these input data as a multidimensional feature vector and calculates an importance score for each article (e.g., 0.0-1.0) using an importance estimation submodule (e.g., multilayer perceptron or gradient boosting decision tree). Examples of AI input include article body such as “A new AI technology was announced at the international conference in June 2024” (3000 tokens), number of views (12,000), number of shares (3,500), impact score (0.92), category (technology), etc. Examples of AI output include importance score (0.95), summary detail parameter (high), summary sentence (“A new AI technology was announced at the international conference, and inference speed has doubled”), etc. The summarization unit sets a large output length control parameter (e.g., max_length=256) in the decoder layer of the summary generation AI when the importance score is high to generate a detailed summary sentence. Conversely, when the importance is low, a short output length such as max_length=64 is specified to generate a concise summary sentence. For moderate importance, an intermediate value such as max_length=128 is used. Furthermore, the summarization unit dynamically adjusts the number of extracted keywords and the number of summary paragraphs according to the importance. These outputs are used for subsequent processing such as display in the user interface, input to the voice generation unit, and saving to the article database. As a technical effect, the summarization unit automatically optimizes the level of detail of the summary according to the importance of the article, enabling users to obtain sufficient information for important articles and quickly grasp the outline of less important articles, thereby greatly improving information acquisition efficiency, user satisfaction, and overall system resource optimization. Compared to conventional uniform summary generation or manual summary adjustment, dynamic detail control by AI brings significant technical improvements in terms of computational efficiency, accuracy, and operational cost. Specific application fields include personalized summaries in news distribution services, extraction of important information in intra-company information sharing, emphasis of key points in educational materials, and emergency information transmission during disasters.

The summarization unit is configured to apply different summarization algorithms during summary generation according to the category of the article. The summarization unit applies different summarization algorithms during summary generation according to the category of the article. For example, the summarization unit uses generative AI to classify the category of the article. The generative AI analyzes the content of the article and classifies the category. The summarization unit applies different summarization algorithms according to the category of the article. For example, for political articles, the summarization unit generates fact-based summaries. For entertainment articles, the summarization unit generates summaries that attract interest. Furthermore, for sports articles, the summarization unit generates summaries focusing on match results and highlights. As a result, it is possible to apply summarization algorithms according to the category of the article. Specifically, the summarization unit first receives the article body (up to 4096 tokens of text array) as input and uses BERT-series text classification models or convolutional neural networks to automatically determine the article category (e.g., politics, economy, entertainment, sports, science, etc.). Examples of AI input include article body such as “A new AI technology was announced at the international conference in June 2024,” article title (“AI technology announced at international conference”), and article metadata (publication date, author, etc.). Examples of AI output include category label (“technology”), category confidence score (0.97), etc. The summarization unit dynamically switches the algorithm selection module of the summary generation AI according to the category determination result. For example, for the politics category, a fact extraction-type summarization algorithm (e.g., information extraction rule-based+Transformer decoder) is applied to explicitly extract major events, stakeholders, dates, etc. For the entertainment category, an emotion analysis submodule is used in combination, and a summary template that emphasizes topics and points of interest is applied. For the sports category, an algorithm that prioritizes extraction of scores, match results, and highlight scenes (e.g., score pattern detection+summary generation) is used. Examples of AI output include political article summary (“New bill passed and will be enforced from June 2024”), entertainment article summary (“Popular actor stars in new movie”), sports article summary (“Japan national team wins 2-1”), etc. These outputs are displayed as optimized summary sentences for each category in the user interface and are also used as input to the voice generation unit and translation unit. As a technical effect, the summarization unit automatically applies the optimal summarization algorithm for each article category, greatly improving information accuracy, user engagement, and information transmission efficiency compared to conventional uniform summary generation. In particular, summary generation tailored to category-specific information structures and user needs is possible, demonstrating high technical utility in diverse fields such as news distribution services, educational materials, sports news, and entertainment information provision.

The summarization unit is configured to estimate the user's emotion and adjust the length of the summary based on the estimated emotion. The summarization unit estimates the user's emotion and adjusts the length of the summary based on the estimated emotion. For example, the summarization unit uses an emotion engine or generative AI to estimate the user's emotion. The emotion engine analyzes data such as the user's facial expression or voice to estimate emotion. The generative AI adjusts the length of the summary based on the user's emotion. For example, if the user is feeling stressed, the summarization unit generates a short and concise summary. If the user is relaxed, the summarization unit generates a detailed summary. Furthermore, if the user is in a hurry, the summarization unit generates a short summary containing only the most important points. As a result, it is possible to adjust the length of the summary according to the user's emotion. Specifically, the summarization unit inputs facial images (224×224×3 pixel RGB images), speech waveform data (16 kHz, 16 bit PCM, 3 seconds), and user input text (up to 256 tokens) into an emotion recognition AI for emotion estimation. The emotion recognition AI uses CNN or RNN-based image and speech encoders to output emotion labels (e.g., stress, relaxation, hurry, etc.) and emotion intensity scores (0.0-1.0). Examples of AI input include a user's smiling image, speech waveform of a calm voice, and short comments (“I'm in a hurry,” etc.). Examples of AI output include emotion label (“stress”), emotion intensity (0.82), and estimation confidence (0.91). The summarization unit dynamically adjusts the output length parameter (max_length) and the number of extracted keywords of the summary generation AI based on the emotion estimation results. For example, in case of stress or hurry, a short summary such as max_length=64 is generated, and in case of relaxation, a detailed summary such as max_length=256 is generated. Furthermore, when emotion intensity is high, more concise or more detailed expressions are emphasized. These outputs are used for user interface display, input to the voice generation unit, saving to the article database, and so on. As a technical effect, the summarization unit automatically optimizes the summary length according to the user's emotional state, greatly improving user experience, information transmission efficiency, and stress reduction compared to conventional uniform summary generation. Application fields include personalized news distribution services, educational information provision, information transmission support in medical and welfare fields, and voice news for visually impaired persons.

The summarization unit is configured to determine the priority of the summary during summary generation based on the publication timing of the article. The summarization unit determines the priority of the summary during summary generation based on the publication timing of the article. For example, the summarization unit uses generative AI to evaluate the publication timing of the article. The generative AI analyzes data such as the publication date and elapsed time since publication to evaluate the publication timing of the article. The summarization unit determines the priority of the summary based on the publication timing of the article. For example, the summarization unit generates summaries for the latest articles with priority. For past articles, the priority of summary generation is adjusted according to importance. Furthermore, articles related to a specific period are prioritized for summary generation. As a result, it is possible to determine the priority of summary generation according to the publication timing of the article. Specifically, the summarization unit receives as input the article body (up to 4096 tokens), article publication date (UNIX timestamp or ISO8601 format), current time, article category, article importance score, etc. The AI calculates the elapsed time (e.g., minutes, hours, days) from the difference between the publication date and the current time and computes a recency score (0.0-1.0). Examples of AI input include article body published on “Jun. 1, 2024,” current time (Jun. 2, 2024), category (technology), importance score (0.92), etc. Examples of AI output include recency score (0.98), summary priority (high), summary generation trigger flag (True), etc. The summarization unit prioritizes articles with high recency scores in the summary generation queue, and for past articles, adjusts priority according to importance or user requests. Articles related to specific periods (e.g., during disasters, event periods, etc.) have their priority increased by a period determination algorithm. These outputs are used for subsequent processing such as display of new articles in the user interface, input to the voice generation unit and translation unit, and push notifications. As a technical effect, the summarization unit automatically controls the priority of summary generation according to the publication timing of the article, enabling users to quickly obtain the latest and most important information, and greatly improving immediacy of information transmission, overall system resource optimization, and user satisfaction. Application fields include breaking news distribution, disaster information transmission, event news, and timely summary generation for intra-company information sharing.

The summarization unit is configured to adjust the order of the summary during summary generation based on the relevance of the article. The summarization unit adjusts the order of the summary during summary generation based on the relevance of the article. For example, the summarization unit uses generative AI to evaluate the relevance of the article. The generative AI analyzes data such as content similarity and topic commonality to evaluate the relevance of the article. The summarization unit adjusts the order of the summary based on the relevance of the article. For example, the summarization unit generates summaries for highly relevant articles with priority. For articles with low relevance, summary generation is delayed. Furthermore, for articles with moderate relevance, summaries are generated in an appropriate order. As a result, it is possible to adjust the order of summary generation according to the relevance of the article. Specifically, the summarization unit receives as input multiple article bodies (each up to 4096 tokens), article titles, article categories, article metadata (publication date, author, etc.), and uses BERT-series semantic vector generation models or topic modeling algorithms (e.g., LDA, Doc2Vec) to calculate semantic similarity scores (0.0-1.0) between articles. Examples of AI input include article A “New AI technology announced,” article B “Social impact of AI technology,” article C “Sports tournament results,” etc., with their bodies and titles. Examples of AI output include relevance score between A and B (0.87), relevance score between A and C (0.12), relevance group ID (e.g., AI technology group), etc. The summarization unit groups articles with high relevance scores and dynamically adjusts the order of the summary generation queue. For example, consecutive articles on the same topic are summarized together and displayed consecutively to the user. Articles with low relevance are delayed, and summary generation is postponed as needed. These outputs are used for subsequent processing such as display of related articles in the user interface, input to the voice generation unit and translation unit, and topic classification in the article database. As a technical effect, the summarization unit controls the order of summary generation based on article relevance, enabling users to efficiently grasp topics of high interest, and greatly improving information search efficiency, user satisfaction, and overall system information organization. Application fields include display of related articles in news distribution services, topic-based summaries in intra-company information sharing, theme-based summaries in educational materials, and integration of related information during disasters.

The answering unit is configured to estimate the user's emotion and adjust the expression method of the answer based on the estimated emotion. The answering unit estimates the user's emotion and adjusts the expression method of the answer based on the estimated emotion. For example, the answering unit uses an emotion engine or generative AI to estimate the user's emotion. The emotion engine analyzes data such as the user's facial expression or voice to estimate emotion. The generative AI adjusts the expression method of the answer based on the user's emotion. For example, if the user is feeling stressed, the answering unit generates an answer using concise and positive expressions. If the user is relaxed, the answering unit generates a detailed answer with a relaxed tone. Furthermore, if the user is in a hurry, the answering unit generates a short answer emphasizing only the most important points. As a result, it is possible to adjust the expression method of the answer according to the user's emotion. Specifically, the answering unit inputs facial images (e.g., 224×224×3 pixel RGB images), speech waveform data (e.g., 16 kHz, 16 bit PCM, 3 seconds), and user input text (e.g., up to 256 tokens) into an emotion recognition AI for emotion estimation. The emotion recognition AI uses CNN or RNN-based image and speech encoders to output emotion labels (e.g., stress, relaxation, hurry, etc.) and emotion intensity scores (0.0-1.0). Examples of AI input include a user's smiling image, speech waveform of a calm voice, and short comments (“I'm in a hurry,” etc.). Examples of AI output include emotion label (“stress”), emotion intensity (0.82), and estimation confidence (0.91). The answering unit dynamically switches the decoder parameters and output templates of the answer generation AI (e.g., Transformer-based large language model) based on these emotion estimation results. For example, in case of stress, positive expressions are prioritized; in case of relaxation, detailed explanations are added; and in case of hurry, only key points are extracted. Examples of output include “New technology has been announced. Details will be provided later.” (in case of stress), “A new AI technology was announced at the international conference in June 2024, and inference speed has doubled.” (in case of relaxation), etc. These outputs are used for user interface display, input to the voice generation unit, saving to the article database, and so on. As a technical effect, the answering unit automatically optimizes answer expressions according to the user's emotional state, greatly improving user experience, information transmission efficiency, and stress reduction compared to conventional uniform answer generation. Application fields include personalized news distribution services, educational information provision, information transmission support in medical and welfare fields, and voice news for visually impaired persons.

The answering unit is configured to adjust the level of detail of the answer during answer generation based on the importance of the question. The answering unit adjusts the level of detail of the answer during answer generation based on the importance of the question. For example, the answering unit uses generative AI to evaluate the importance of the question. The generative AI analyzes data such as the frequency and impact of the question to evaluate its importance. The answering unit adjusts the level of detail of the answer based on the importance of the question. For example, for highly important questions, the answering unit generates a detailed answer. For questions of low importance, the answering unit generates a concise answer. Furthermore, for questions of moderate importance, the answering unit generates an answer with an appropriate level of detail. As a result, it is possible to adjust the level of detail of the answer according to the importance of the question. Specifically, the answering unit receives as input the question sentence (up to 256 tokens), submission frequency (integer value), impact score (0.0-1.0), question category (e.g., technology, economy, etc.), and other metadata. The answering unit integrates these input data as a multidimensional feature vector and calculates an importance score for each question (e.g., 0.0-1.0) using an importance estimation submodule (e.g., multilayer perceptron or gradient boosting decision tree). Examples of AI input include question sentence such as “What are the features of this AI technology?”, submission frequency (120 times), impact score (0.92), category (technology), etc. Examples of AI output include importance score (0.95), answer detail parameter (high), answer sentence (“The new AI technology has doubled inference speed compared to conventional technology and reduced power consumption by 30%”), etc. The answering unit sets a large output length control parameter (e.g., max_length=256) in the decoder layer of the answer generation AI when the importance score is high to generate a detailed answer sentence. Conversely, when the importance is low, a short output length such as max_length=64 is specified to generate a concise answer sentence. For moderate importance, an intermediate value such as max_length=128 is used. Furthermore, the answering unit dynamically adjusts the number of extracted keywords and the number of answer paragraphs according to the importance. These outputs are used for subsequent processing such as display in the user interface, input to the voice generation unit, and saving to the article database. As a technical effect, the answering unit automatically optimizes the level of detail of the answer according to the importance of the question, enabling users to obtain sufficient information for important questions and quickly grasp the outline of less important questions, thereby greatly improving information acquisition efficiency, user satisfaction, and overall system resource optimization. Compared to conventional uniform answer generation or manual answer adjustment, dynamic detail control by AI brings significant technical improvements in terms of computational efficiency, accuracy, and operational cost. Specific application fields include personalized answers in news distribution services, extraction of important information in intra-company information sharing, emphasis of key points in educational materials, and emergency information transmission during disasters.

The answering unit is configured to apply different answer algorithms during answer generation according to the category of the question. The answering unit applies different answer algorithms during answer generation according to the category of the question. For example, the answering unit uses generative AI to classify the category of the question. The generative AI analyzes the content of the question and classifies the category. The answering unit applies different answer algorithms according to the category of the question. For example, for questions about politics, the answering unit generates fact-based answers. For questions about entertainment, the answering unit generates answers that attract interest. Furthermore, for questions about sports, the answering unit generates answers focusing on match results and highlights. As a result, it is possible to apply answer algorithms according to the category of the question. Specifically, the answering unit receives as input the question sentence (up to 256 tokens), question title, question metadata (submission date, user ID, etc.), and uses BERT-series text classification models or convolutional neural networks to automatically determine the question category (e.g., politics, economy, entertainment, sports, science, etc.). Examples of AI input include question sentence such as “What is the content of the new bill?”, question title (“About the bill”), submission date (Jun. 1, 2024), etc. Examples of AI output include category label (“politics”), category confidence score (0.97), etc. The answering unit dynamically switches the algorithm selection module of the answer generation AI according to the category determination result. For example, for the politics category, a fact extraction-type answer algorithm (e.g., information extraction rule-based+Transformer decoder) is applied to explicitly extract major events, stakeholders, dates, etc. For the entertainment category, an emotion analysis submodule is used in combination, and an answer template that emphasizes topics and points of interest is applied. For the sports category, an algorithm that prioritizes extraction of scores, match results, and highlight scenes (e.g., score pattern detection+answer generation) is used. Examples of AI output include political question answer (“The new bill will be enforced from June 2024”), entertainment question answer (“Popular actor stars in new movie”), sports question answer (“Japan national team won 2-1”), etc. These outputs are displayed as optimized answer sentences for each category in the user interface and are also used as input to the voice generation unit and translation unit. As a technical effect, the answering unit automatically applies the optimal answer algorithm for each question category, greatly improving information accuracy, user engagement, and information transmission efficiency compared to conventional uniform answer generation. In particular, answer generation tailored to category-specific information structures and user needs is possible, demonstrating high technical utility in diverse fields such as news distribution services, educational materials, sports news, and entertainment information provision.

The answering unit is configured to estimate the user's emotion and adjust the length of the answer based on the estimated emotion. The answering unit estimates the user's emotion and adjusts the length of the answer based on the estimated emotion. For example, the answering unit uses an emotion engine or generative AI to estimate the user's emotion. The emotion engine analyzes data such as the user's facial expression or voice to estimate emotion. The generative AI adjusts the length of the answer based on the user's emotion. For example, if the user is feeling stressed, the answering unit generates a short and concise answer. If the user is relaxed, the answering unit generates a detailed answer. Furthermore, if the user is in a hurry, the answering unit generates a short answer containing only the most important points. As a result, it is possible to adjust the length of the answer according to the user's emotion. Specifically, the answering unit inputs facial images (224×224×3 pixel RGB images), speech waveform data (16 kHz, 16 bit PCM, 3 seconds), and user input text (up to 256 tokens) into an emotion recognition AI for emotion estimation. The emotion recognition AI uses CNN or RNN-based image and speech encoders to output emotion labels (e.g., stress, relaxation, hurry, etc.) and emotion intensity scores (0.0-1.0). Examples of AI input include a user's smiling image, speech waveform of a calm voice, and short comments (“I'm in a hurry,” etc.). Examples of AI output include emotion label (“stress”), emotion intensity (0.82), and estimation confidence (0.91). The answering unit dynamically adjusts the output length parameter (max_length) and the number of extracted keywords of the answer generation AI based on the emotion estimation results. For example, in case of stress or hurry, a short answer such as max_length=64 is generated, and in case of relaxation, a detailed answer such as max_length=256 is generated. Furthermore, when emotion intensity is high, more concise or more detailed expressions are emphasized. These outputs are used for user interface display, input to the voice generation unit, saving to the article database, and so on. As a technical effect, the answering unit automatically optimizes the answer length according to the user's emotional state, greatly improving user experience, information transmission efficiency, and stress reduction compared to conventional uniform answer generation. Application fields include personalized news distribution services, educational information provision, information transmission support in medical and welfare fields, and voice news for visually impaired persons.

The answering unit is configured to determine the priority of the answer during answer generation based on the submission timing of the question. The answering unit determines the priority of the answer during answer generation based on the submission timing of the question. For example, the answering unit uses generative AI to evaluate the submission timing of the question. The generative AI analyzes data such as the submission date and elapsed time since submission to evaluate the submission timing of the question. The answering unit determines the priority of the answer based on the submission timing of the question. For example, the answering unit generates answers for the latest questions with priority. For past questions, the priority of answer generation is adjusted according to importance. Furthermore, questions related to a specific period are prioritized for answer generation. As a result, it is possible to determine the priority of answer generation according to the submission timing of the question. Specifically, the answering unit receives as input the question sentence (up to 256 tokens), question submission date (UNIX timestamp or ISO8601 format), current time, question category, question importance score, etc. The AI calculates the elapsed time (e.g., minutes, hours, days) from the difference between the submission date and the current time and computes a recency score (0.0-1.0). Examples of AI input include question sentence submitted on “Jun. 1, 2024,” current time (Jun. 2, 2024), category (technology), importance score (0.92), etc. Examples of AI output include recency score (0.98), answer priority (high), answer generation trigger flag (True), etc. The answering unit prioritizes questions with high recency scores in the answer generation queue, and for past questions, adjusts priority according to importance or user requests. Questions related to specific periods (e.g., during disasters, event periods, etc.) have their priority increased by a period determination algorithm. These outputs are used for subsequent processing such as display of new questions in the user interface, input to the voice generation unit and translation unit, and push notifications. As a technical effect, the answering unit automatically controls the priority of answer generation according to the submission timing of the question, enabling users to quickly obtain the latest and most important information, and greatly improving immediacy of information transmission, overall system resource optimization, and user satisfaction. Application fields include breaking news distribution, disaster information transmission, event news, and timely answer generation for intra-company information sharing.

The answering unit is configured to adjust the order of the answer during answer generation based on the relevance of the question. The answering unit adjusts the order of the answer during answer generation based on the relevance of the question. For example, the answering unit uses generative AI to evaluate the relevance of the question. The generative AI analyzes data such as content similarity and topic commonality to evaluate the relevance of the question. The answering unit adjusts the order of the answer based on the relevance of the question. For example, the answering unit generates answers for highly relevant questions with priority. For questions with low relevance, answer generation is delayed. Furthermore, for questions with moderate relevance, answers are generated in an appropriate order. As a result, it is possible to adjust the order of answer generation according to the relevance of the question. Specifically, the answering unit receives as input multiple question sentences (each up to 256 tokens), question titles, question categories, question metadata (submission date, user ID, etc.), and uses BERT-series semantic vector generation models or topic modeling algorithms (e.g., LDA, Doc2Vec) to calculate semantic similarity scores (0.0-1.0) between questions. Examples of AI input include question A “What are the features of the new AI technology?”, question B “What is the social impact of AI technology?”, question C “What are the results of the sports tournament?”, etc., with their bodies and titles. Examples of AI output include relevance score between A and B (0.87), relevance score between A and C (0.12), relevance group ID (e.g., AI technology group), etc. The answering unit groups questions with high relevance scores and dynamically adjusts the order of the answer generation queue. For example, consecutive questions on the same topic are answered together and displayed consecutively to the user. Questions with low relevance are delayed, and answer generation is postponed as needed. These outputs are used for subsequent processing such as display of related questions in the user interface, input to the voice generation unit and translation unit, and topic classification in the question database. As a technical effect, the answering unit controls the order of answer generation based on question relevance, enabling users to efficiently grasp topics of high interest, and greatly improving information search efficiency, user satisfaction, and overall system information organization. Application fields include display of related questions in news distribution services, topic-based answers in intra-company information sharing, theme-based answers in educational materials, and integration of related information during disasters.

The voice generation unit is configured to estimate the user's emotion and adjust the tone and speed of the speech based on the estimated emotion. The voice generation unit estimates the user's emotion and adjusts the tone and speed of the speech based on the estimated emotion. For example, the voice generation unit uses an emotion engine or generative AI to estimate the user's emotion. The emotion engine analyzes data such as the user's facial expression or voice to estimate emotion. The generative AI adjusts the tone and speed of the speech based on the user's emotion. For example, if the user is feeling stressed, the voice generation unit generates speech with a calm tone and slow speed. If the user is relaxed, the voice generation unit generates speech with a relaxed tone and natural speed. Furthermore, if the user is in a hurry, the voice generation unit generates speech with a quick and concise tone. As a result, it is possible to adjust the tone and speed of the speech according to the user's emotion. Specifically, the voice generation unit inputs facial images (e.g., 224×224×3 pixel RGB images), speech waveform data (e.g., 16 kHz, 16 bit PCM, 3 seconds), and user input text (e.g., up to 256 tokens) into an emotion recognition AI for emotion estimation. The emotion recognition AI uses CNN or RNN-based image and speech encoders to output emotion labels (e.g., stress, relaxation, hurry, etc.) and emotion intensity scores (0.0-1.0). Examples of AI input include a user's smiling image, speech waveform of a calm voice, and short comments (“I'm in a hurry,” etc.). Examples of AI output include emotion label (“stress”), emotion intensity (0.82), and estimation confidence (0.91). The voice generation unit dynamically adjusts the parameters of the speech synthesis AI (e.g., WaveNet or Tacotron2 deep neural network-based speech synthesis models) based on these emotion estimation results. Specifically, if the emotion label is “stress,” the tone parameter of the speech synthesis model is set to “calm voice,” and the playback speed parameter is set to a slower value such as 0.8× speed. If the emotion label is “relaxation,” the tone is set to “relaxed voice,” and the speed is set to 1.0× (standard). If the emotion label is “hurry,” the tone is set to “clear and concise voice,” and the speed is set to a faster value such as 1.2× speed. Examples of AI input for speech generation include text data (“New technology has been announced”), emotion label (“stress”), tone specification (“calm voice”), speed specification (0.8× speed), etc., and examples of AI output include speech waveform data, speech length (seconds), speech quality score, etc. These outputs are used for subsequent processing such as speech playback in the user interface, saving to the article database, and push notifications to users. As a technical effect, the voice generation unit automatically optimizes speech tone and speed according to the user's emotional state, greatly improving user experience, information transmission efficiency, and stress reduction compared to conventional uniform speech synthesis. Application fields include personalized speech in news distribution services, educational information provision, speech information transmission support in medical and welfare fields, and voice news for visually impaired persons.

The voice generation unit can adjust the level of detail of speech based on the importance of the article during speech conversion. The voice generation unit adjusts the level of detail of speech based on the importance of the article during speech conversion. For example, the voice generation unit evaluates the importance of the article using generative AI. The generative AI analyzes data such as the number of article views and the impact of the content to evaluate the importance of the article. The voice generation unit adjusts the level of detail of speech based on the importance of the article. For example, for articles with high importance, the voice generation unit generates detailed speech. For articles with low importance, the voice generation unit generates concise speech. Furthermore, for articles with moderate importance, the voice generation unit generates speech with an appropriate level of detail. This enables the level of detail of speech to be adjusted according to the importance of the article. Specifically, the voice generation unit receives as input metadata such as the article body (a Japanese text array of up to 4096 tokens), the number of article views (integer value), the number of shares on SNS (integer value), the impact score of the article content (real value from 0.0 to 1.0), and the article category (e.g., politics, economy, entertainment, etc.). The voice generation unit integrates these input data into a multidimensional feature vector and calculates an importance score for each article (e.g., 0.0 to 1.0) using an importance estimation submodule (e.g., multilayer perceptron or gradient boosting decision tree). An example input to the AI includes an article body such as “New AI technology was announced at the international conference in June 2024” (3000 tokens), number of views (12,000), number of shares (3,500), impact score (0.92), and category (technology). Example outputs from the AI include an importance score (0.95), speech detail parameter (high), and speech conversion text (“New AI technology was announced at the international conference, and inference speed doubled”). When the importance score is high, the voice generation unit sets a large output length control parameter (e.g., max_length=256) in the decoder layer of the speech synthesis AI, generates detailed speech conversion text, and inputs it to the speech synthesis model. Conversely, when the importance is low, a short output length such as max_length=64 is specified to generate concise speech conversion text. For moderate importance, an intermediate value such as max_length=128 is used. Furthermore, the voice generation unit dynamically adjusts the number of keywords extracted and the number of paragraphs in the speech conversion text according to the importance. Example inputs to the AI for speech conversion include speech conversion text and speech detail parameter (high/medium/low), and example outputs include speech waveform data, speech length (seconds), and speech quality score. These outputs are used for subsequent processing such as playback in the user interface, storage in the article database, and push notifications to users. As a technical effect, the voice generation unit automatically optimizes the level of detail of speech according to the importance of the article, enabling users to obtain sufficient information for important articles and quickly grasp the summary of less important articles, thereby greatly improving information acquisition efficiency, user satisfaction, and overall system resource optimization. Compared to conventional uniform speech conversion or manual speech adjustment, dynamic detail control by AI brings significant technical improvements in terms of computational efficiency, accuracy, and operational cost. Specific application fields include personalized speech for news distribution services, speech conversion of important information for internal corporate information sharing, emphasis of key points in educational materials, and emergency information speech transmission during disasters.

The voice generation unit can apply different speech algorithms according to the category of the article during speech conversion. The voice generation unit applies different speech algorithms according to the category of the article during speech conversion. For example, the voice generation unit classifies the category of the article using generative AI. The generative AI analyzes the content of the article and classifies the category. The voice generation unit applies different speech algorithms according to the category of the article. For example, for political articles, the voice generation unit generates speech based on facts. For entertainment articles, the voice generation unit generates speech that attracts interest. Furthermore, for sports articles, the voice generation unit generates speech focusing on match results and highlights. This enables the application of speech algorithms according to the category of the article. Specifically, the voice generation unit receives as input the article body (a text array of up to 4096 tokens), article title, and article metadata (publication date, author, etc.), and automatically determines the article category (e.g., politics, economy, entertainment, sports, science, etc.) using BERT-based text classification models or convolutional neural networks. Example inputs to the AI include an article body such as “New AI technology was announced at the international conference in June 2024,” article title (“AI technology announced at international conference”), and article metadata (publication date, author, etc.). Example outputs from the AI include category label (“technology”) and category confidence score (0.97). The voice generation unit dynamically switches the algorithm selection module of the speech synthesis AI according to the category determination result. For example, for the politics category, a fact extraction-type speech conversion algorithm (e.g., information extraction rule-based +WaveNet decoder) is applied to explicitly convert major events, stakeholders, and dates into speech. For the entertainment category, an emotion analysis submodule is used in combination, and a speech template that emphasizes topics and points of interest is applied. For the sports category, an algorithm that preferentially extracts scores, match results, and highlight scenes (e.g., score pattern detection+speech generation) is used. Example outputs from the AI include political article speech (“The new bill was passed and will be enforced from June 2024”), entertainment article speech (“A popular actor stars in a new movie”), and sports article speech (“Japan national team won 2-1”). These outputs are played as speech data optimized for each category in the user interface and are also used for subsequent processing such as storage in the article database and push notifications. As a technical effect, the voice generation unit automatically applies the optimal speech algorithm for each article category, greatly improving information accuracy, user engagement, and information transmission efficiency compared to conventional uniform speech synthesis. In particular, speech generation tailored to category-specific information structures and user needs is possible, demonstrating high technical utility in various fields such as news distribution services, educational materials, sports news, and entertainment information provision.

The voice generation unit can estimate the user's emotion and adjust the length of speech based on the estimated user's emotion. The voice generation unit estimates the user's emotion and adjusts the length of speech based on the estimated user's emotion. For example, the voice generation unit estimates the user's emotion using an emotion engine or generative AI. The emotion engine analyzes data such as the user's facial expressions and voice to estimate emotion. The generative AI adjusts the length of speech based on the user's emotion. For example, if the user is feeling stressed, the voice generation unit generates short and concise speech. If the user is relaxed, the voice generation unit generates detailed speech. Furthermore, if the user is in a hurry, the voice generation unit generates short speech containing only the most important points. This enables the length of speech to be adjusted according to the user's emotion. Specifically, the voice generation unit inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., stress, relaxation, hurry) and emotion intensity scores (0.0 to 1.0). Example inputs to the AI include a smiling facial image, calm voice waveform, and short comment (“I'm in a hurry”). Example outputs from the AI include emotion label (“stress”), emotion intensity (0.82), and estimation confidence (0.91). The voice generation unit dynamically adjusts the output length parameter (max_length) and the number of extracted keywords in the speech synthesis AI based on the emotion estimation results. For example, in cases of stress or hurry, short speech with max_length=64 is generated, and in cases of relaxation, detailed speech with max_length=256 is generated. Furthermore, when emotion intensity is high, more concise or more detailed expressions are emphasized. Example inputs to the AI for speech conversion include speech conversion text, max_length specification, and emotion label, and example outputs include speech waveform data, speech length (seconds), and speech quality score. These outputs are used for subsequent processing such as user interface display, storage in the article database, and push notifications. As a technical effect, the voice generation unit automatically optimizes speech length according to the user's emotional state, greatly improving user experience, information transmission efficiency, and stress reduction compared to conventional uniform speech generation. Application fields include personalized speech for news distribution services, educational information provision, voice information transmission support in medical and welfare fields, and voice news for visually impaired users.

The voice generation unit can determine the priority of speech based on the publication timing of the article during speech conversion. The voice generation unit determines the priority of speech based on the publication timing of the article during speech conversion. For example, the voice generation unit evaluates the publication timing of the article using generative AI. The generative AI analyzes data such as the publication date of the article and the elapsed time since publication to evaluate the publication timing. The voice generation unit determines the priority of speech based on the publication timing of the article. For example, the latest articles are prioritized for speech generation. Past articles have their speech priority adjusted according to their importance. Furthermore, articles related to specific periods are prioritized for speech generation. This enables the priority of speech to be adjusted according to the publication timing of the article. Specifically, the voice generation unit receives as input the article body (up to 4096 tokens), article publication date (UNIX timestamp or ISO8601 format), current time, article category, and article importance score. The AI calculates the elapsed time (e.g., in minutes, hours, days) from the difference between the publication date and the current time and computes a recency score (0.0 to 1.0). Example inputs to the AI include an article body published on Jun. 1, 2024, current time (Jun. 2, 2024), category (technology), and importance score (0.92). Example outputs from the AI include recency score (0.98), speech generation priority (high), and speech generation trigger flag (True). The voice generation unit prioritizes articles with high recency scores in the speech generation queue, and adjusts the priority of past articles according to their importance or user requests. Articles related to specific periods (e.g., during disasters or events) have their priority increased by a period determination algorithm. These outputs are used for subsequent processing such as playback of new article speech in the user interface, storage in the article database, and push notifications. As a technical effect, the voice generation unit automatically controls the priority of speech generation according to the publication timing of the article, enabling users to quickly obtain the latest and most important information, and greatly improving the immediacy of information transmission, overall system resource optimization, and user satisfaction. Application fields include breaking news distribution, disaster information speech transmission, event news speech, and timely speech generation for internal corporate information sharing.

The voice generation unit can adjust the order of speech based on the relevance of the article during speech conversion. The voice generation unit adjusts the order of speech based on the relevance of the article during speech conversion. For example, the voice generation unit evaluates the relevance of articles using generative AI. The generative AI analyzes data such as content similarity and topic commonality to evaluate article relevance. The voice generation unit adjusts the order of speech based on the relevance of the article. For example, articles with high relevance are prioritized for speech generation. Articles with low relevance are generated later. Furthermore, articles with moderate relevance are generated in an appropriate order. This enables the order of speech to be adjusted according to the relevance of the article. Specifically, the voice generation unit receives as input multiple article bodies (each up to 4096 tokens), article titles, article categories, and article metadata (publication date, author, etc.), and calculates semantic similarity scores (0.0 to 1.0) between articles using BERT-based semantic vector generation models or topic modeling algorithms (e.g., LDA, Doc2Vec). Example inputs to the AI include article A “New AI technology announced,” article B “Social impact of AI technology,” and article C “Sports event results,” including their bodies and titles. Example outputs from the AI include relevance score between A and B (0.87), relevance score between A and C (0.12), and related group ID (e.g., AI technology group). The voice generation unit groups articles with high relevance scores and dynamically adjusts the order of the speech generation queue. For example, consecutive articles on the same topic are collectively converted to speech and played consecutively to the user. Articles with low relevance are delayed for speech generation as needed. These outputs are used for subsequent processing such as playback of related article speech in the user interface, topic classification in the article database, and push notifications. As a technical effect, the voice generation unit controls the order of speech based on article relevance, enabling users to efficiently grasp topics of high interest, and greatly improving information search efficiency, user satisfaction, and overall system information organization. Application fields include playback of related article speech in news distribution services, topic-based speech conversion for internal corporate information sharing, theme-based speech conversion for educational materials, and integration of related information speech during disasters.

The reporting unit can estimate the user's emotion and determine the priority of reports based on the estimated user's emotion. The reporting unit estimates the user's emotion and determines the priority of reports based on the estimated user's emotion. For example, the reporting unit estimates the user's emotion using an emotion engine or generative AI. The emotion engine analyzes data such as the user's facial expressions and voice to estimate emotion. The generative AI determines the priority of reports based on the user's emotion. For example, if the user feels strong dissatisfaction, the reporting unit prioritizes processing that report. If the user feels mild dissatisfaction, the reporting unit processes the report with normal priority. Furthermore, if the user does not feel any particular dissatisfaction, the reporting unit processes the report later. This enables the priority of reports to be adjusted according to the user's emotion. Specifically, the reporting unit inputs facial images (e.g., 224×224×3 pixel RGB images), voice waveform data (e.g., 16 kHz, 16 bit PCM, 3 seconds), and user input text (e.g., up to 256 tokens) to an emotion recognition AI for emotion estimation. The emotion recognition AI uses CNN or RNN-based image and voice encoders to output emotion labels (e.g., strong dissatisfaction, mild dissatisfaction, normal) and emotion intensity scores (0.0 to 1.0). Example inputs to the AI include an angry facial image, strong-toned voice waveform, and short comment such as “very unpleasant.” Example outputs from the AI include emotion label (“strong dissatisfaction”), emotion intensity (0.95), and estimation confidence (0.93). The reporting unit dynamically adjusts the priority parameters of the report queue based on these emotion estimation results. For example, if the emotion intensity is 0.8 or higher, the report is placed in the highest priority queue; if between 0.4 and 0.8, in the normal queue; and if below 0.4, in the low priority queue. The reporting unit processes reports in order of priority, proceeding to AI-based content analysis or administrator review. In subsequent AI processing, reliability scores for the report content, duplicate detection, and cluster ID assignment are performed, and notification and headline correction algorithm trigger timing are controlled according to priority. As a technical effect, the reporting unit accurately estimates the user's emotional state and automatically optimizes the priority of report processing, enabling rapid detection and response to urgent and important issues compared to conventional uniform reporting or manual priority judgment, thereby greatly improving headline quality management, prevention of misinformation spread, and user satisfaction. Specific application fields include headline auditing for news distribution services, misinformation countermeasures for SNS and bulletin boards, reliability improvement for educational news materials, and content auditing for internal corporate information sharing systems.

The reporting unit can refer to past report data during reporting to improve the accuracy of reports. The reporting unit refers to past report data during reporting to improve the accuracy of reports. For example, the reporting unit analyzes past report data and, if there are many similar reports, prioritizes processing those reports. The reporting unit evaluates the reliability of report content based on past report data. Furthermore, the reporting unit checks the consistency of report content by referring to past report data. This enables the accuracy of reports to be improved by referring to past report data. Specifically, the reporting unit is equipped with an indexed data store for fast searching and aggregation of past report content accumulated in the report database (e.g., structured data such as article ID, report reason, user ID, report time, comments, etc.). When a new report is input, the reporting unit uses an AI module to vectorize past reports for the same or similar articles and calculates semantic similarity (e.g., cosine similarity 0.0 to 1.0). Example inputs to the AI include the text of a new report (“This headline is exaggerated”), article ID (12345), report reason (“exaggeration”), and report history for the same article over the past 30 days (up to 100 cases). Example outputs from the AI include the number of similar reports (15 cases), reliability score (0.92), and consistency judgment label (“consistent”). If the number of similar reports exceeds a predetermined threshold (e.g., 10 cases), the reporting unit places the relevant report in the priority queue and quickly triggers the headline correction algorithm or administrator review by AI. Furthermore, reliability evaluation of report content also considers the reliability profile of past reporters, the distribution of report reasons, and natural language analysis results of report content (e.g., exaggeration detection score). Consistency confirmation of report content is automatically determined by checking past correction history and consistency with existing cluster IDs. These outputs are used for subsequent processing such as headline optimization, user notification, and prioritization of administrator review. As a technical effect, the reporting unit refers to and analyzes past report data from multiple perspectives using AI, greatly improving report accuracy, reliability, and consistency, as well as system-wide automation, speed, and prevention of misinformation spread compared to conventional simple report counting or manual history checking. Specific application fields include headline quality management for news distribution services, misinformation countermeasures for SNS and bulletin boards, reliability improvement for educational news materials, and content auditing for internal corporate information sharing systems.

The reporting unit can estimate the user's emotion and adjust the display method of reports based on the estimated user's emotion. The reporting unit estimates the user's emotion and adjusts the display method of reports based on the estimated user's emotion. For example, the reporting unit estimates the user's emotion using an emotion engine or generative AI. The emotion engine analyzes data such as the user's facial expressions and voice to estimate emotion. The generative AI adjusts the display method of reports based on the user's emotion. For example, if the user feels strong dissatisfaction, the reporting unit displays the report content with emphasis. If the user feels mild dissatisfaction, the reporting unit displays the report content in the normal display method. Furthermore, if the user does not feel any particular dissatisfaction, the reporting unit displays the report content in a subdued manner. This enables the display method of reports to be adjusted according to the user's emotion. Specifically, the reporting unit inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., strong dissatisfaction, mild dissatisfaction, normal) and emotion intensity scores (0.0 to 1.0). Example inputs to the AI include an angry facial image, strong-toned voice waveform, and short comment such as “very unpleasant.” Example outputs from the AI include emotion label (“strong dissatisfaction”), emotion intensity (0.95), and estimation confidence (0.93). The reporting unit dynamically adjusts the display style of report content on the user interface (e.g., highlight color, font size, display position, etc.) based on these emotion estimation results. For example, in cases of strong dissatisfaction, the report is displayed prominently in red or bold font; in cases of mild dissatisfaction, standard display is used; and in cases of no particular dissatisfaction, the report is displayed in pale color or smaller font. Furthermore, the display order and notification frequency of report content can also be controlled according to emotion intensity. These outputs are used for subsequent processing such as alerting administrators and other users, triggering headline correction algorithms, and user notifications. As a technical effect, the reporting unit automatically optimizes the display method of reports according to the user's emotional state, enabling urgent and important reports to be visualized quickly and accurately compared to conventional uniform display or manual emphasis judgment, thereby greatly improving headline quality management, prevention of misinformation spread, and user satisfaction. Specific application fields include headline auditing for news distribution services, misinformation countermeasures for SNS and bulletin boards, reliability improvement for educational news materials, and content auditing for internal corporate information sharing systems.

The translation unit can estimate the user's emotion and adjust the expression method of translation based on the estimated user's emotion. The translation unit estimates the user's emotion and adjusts the expression method of translation based on the estimated user's emotion. For example, the translation unit estimates the user's emotion using an emotion engine or generative AI. The emotion engine analyzes data such as the user's facial expressions and voice to estimate emotion. The generative AI adjusts the expression method of translation based on the user's emotion. For example, if the user is feeling stressed, the translation unit generates a concise and positive translation. If the user is relaxed, the translation unit generates a detailed translation with a relaxed tone. Furthermore, if the user is in a hurry, the translation unit generates a short translation emphasizing only the most important points. This enables the expression method of translation to be adjusted according to the user's emotion. Specifically, the translation unit inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., stress, relaxation, hurry) and emotion intensity scores (0.0 to 1.0). Example inputs to the AI include a confused facial image, tense voice waveform, and short comment such as “I'm in a hurry.” Example outputs from the AI include emotion label (“stress”), emotion intensity (0.82), and estimation confidence (0.91). The translation unit dynamically switches the decoder parameters and output templates of the Transformer-type neural machine translation model based on these emotion estimation results. For example, in cases of stress, positive expressions and concise style are prioritized; in cases of relaxation, detailed explanations and a soft tone are added; and in cases of hurry, a short translation containing only the main points is generated. Example outputs include “New technology has been announced. Details will be provided later.” (in case of stress) and “New AI technology was announced at the international conference in June 2024, and inference speed has doubled.” (in case of relaxation). These outputs are used for subsequent processing such as user interface display, input to the voice generation unit, and storage in the article database. As a technical effect, the translation unit automatically optimizes translation expression according to the user's emotional state, greatly improving user experience, information transmission efficiency, and stress reduction compared to conventional uniform translation generation. Application fields include international news distribution, educational information provision, multilingual information transmission support in medical and welfare fields, and voice news for visually impaired users.

The translation unit can adjust the level of detail of translation based on the importance of the article during translation. The translation unit adjusts the level of detail of translation based on the importance of the article during translation. For example, the translation unit evaluates the importance of the article using generative AI. The generative AI analyzes data such as the number of article views and the impact of the content to evaluate the importance of the article. The translation unit adjusts the level of detail of translation based on the importance of the article. For example, for articles with high importance, the translation unit generates detailed translations. For articles with low importance, the translation unit generates concise translations. Furthermore, for articles with moderate importance, the translation unit generates translations with an appropriate level of detail. This enables the level of detail of translation to be adjusted according to the importance of the article. Specifically, the translation unit uses a Transformer-based neural machine translation model and receives as input a token sequence of the article body (up to 4096 tokens), the number of article views (integer value), the number of shares on SNS (integer value), the impact score of the article content (real value from 0.0 to 1.0), and the article category (e.g., politics, economy, entertainment, etc.). The translation unit integrates these input data into a multidimensional feature vector and calculates an importance score for each article (0.0 to 1.0) using an importance estimation submodule (e.g., multilayer perceptron or gradient boosting decision tree). Example inputs to the AI include an article body such as “New AI technology was announced at the international conference in June 2024” (3000 tokens), number of views (12,000), number of shares (3,500), impact score (0.92), and category (technology). Example outputs from the AI include importance score (0.95), translation detail parameter (high), and translation text (“New AI technology was announced at the international conference, and inference speed doubled”). When the importance score is high, the translation unit sets a large output length control parameter (e.g., max_length=256) in the decoder layer of the translation generation AI and generates detailed translation text. Conversely, when the importance is low, a short output length such as max_length=64 is specified to generate concise translation text. For moderate importance, an intermediate value such as max_length=128 is used. Furthermore, the translation unit dynamically adjusts the number of keywords extracted and the number of paragraphs in the translation text according to the importance. These outputs are used for subsequent processing such as display in the user interface, input to the voice generation unit, and storage in the article database. As a technical effect, the translation unit automatically optimizes the level of detail of translation according to the importance of the article, enabling users to obtain sufficient information for important articles and quickly grasp the summary of less important articles, thereby greatly improving information acquisition efficiency, user satisfaction, and overall system resource optimization. Compared to conventional uniform translation generation or manual translation adjustment, dynamic detail control by AI brings significant technical improvements in terms of computational efficiency, accuracy, and operational cost. Specific application fields include international news distribution, translation of important information for internal corporate information sharing, emphasis of key points in educational materials, and multilingual transmission of emergency information during disasters.

The translation unit can apply different translation algorithms according to the category of the article during translation. The translation unit applies different translation algorithms according to the category of the article during translation. For example, the translation unit classifies the category of the article using generative AI. The generative AI analyzes the content of the article and classifies the category. The translation unit applies different translation algorithms according to the category of the article. For example, for political articles, the translation unit generates translations based on facts. For entertainment articles, the translation unit generates translations that attract interest. Furthermore, for sports articles, the translation unit generates translations focusing on match results and highlights. This enables the application of translation algorithms according to the category of the article. Specifically, the translation unit receives as input the article body (a text array of up to 4096 tokens), article title, and article metadata (publication date, author, etc.), and automatically determines the article category (e.g., politics, economy, entertainment, sports, science, etc.) using BERT-based text classification models or convolutional neural networks. Example inputs to the AI include an article body such as “New AI technology was announced at the international conference in June 2024,” article title (“AI technology announced at international conference”), and article metadata (publication date, author, etc.). Example outputs from the AI include category label (“technology”) and category confidence score (0.97). The translation unit dynamically switches the algorithm selection module of the machine translation AI according to the category determination result. For example, for the politics category, a fact extraction-type translation algorithm (information extraction rule-based+Transformer decoder) is applied to explicitly translate major events, stakeholders, and dates. For the entertainment category, an emotion analysis submodule is used in combination, and a translation template that emphasizes topics and points of interest is applied. For the sports category, an algorithm that preferentially extracts scores, match results, and highlight scenes (score pattern detection+translation generation) is used. Example outputs from the AI include political article translation (“The new bill was passed and will be enforced from June 2024”), entertainment article translation (“A popular actor stars in a new movie”), and sports article translation (“Japan national team won 2-1”). These outputs are displayed as translation texts optimized for each category in the user interface and are also used for input to the voice generation unit and storage in the article database. As a technical effect, the translation unit automatically applies the optimal translation algorithm for each article category, greatly improving information accuracy, user engagement, and information transmission efficiency compared to conventional uniform translation generation. In particular, translation generation tailored to category-specific information structures and user needs is possible, demonstrating high technical utility in various fields such as international news distribution, educational materials, sports news, and entertainment information provision.

The translation unit can estimate the user's emotion and adjust the length of translation based on the estimated user's emotion. The translation unit estimates the user's emotion and adjusts the length of translation based on the estimated user's emotion. For example, the translation unit estimates the user's emotion using an emotion engine or generative AI. The emotion engine analyzes data such as the user's facial expressions and voice to estimate emotion. The generative AI adjusts the length of translation based on the user's emotion. For example, if the user is feeling stressed, the translation unit generates short and concise translations. If the user is relaxed, the translation unit generates detailed translations. Furthermore, if the user is in a hurry, the translation unit generates short translations containing only the most important points. This enables the length of translation to be adjusted according to the user's emotion. Specifically, the translation unit inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., stress, relaxation, hurry) and emotion intensity scores (0.0 to 1.0). Example inputs to the AI include a confused facial image, tense voice waveform, and short comment such as “I'm in a hurry.” Example outputs from the AI include emotion label (“stress”), emotion intensity (0.82), and estimation confidence (0.91). The translation unit dynamically adjusts the output length control parameter (max_length) and the number of extracted keywords in the Transformer-type neural machine translation model based on these emotion estimation results. For example, in cases of stress or hurry, short translations with max_length=64 are generated, and in cases of relaxation, detailed translations with max_length=256 are generated. Furthermore, when emotion intensity is high, more concise or more detailed expressions are emphasized. Example inputs to the AI for translation include English article body (“The AI system achieved a breakthrough in June 2024.”), article title, article category (e.g., technology, economy), and emotion label (“stress”). Example outputs from the AI include short translation (“AI [symbol] [symbol] ”), detailed translation (“2024 [symbol] 6 [symbol] AI [symbol] [symbol] [symbol] ”), and translation confidence score (0.93). The translation unit combines key point extraction algorithms and redundancy reduction modules according to emotion estimation results to generate translation texts optimized for the user's state. These outputs are used for subsequent processing such as user interface display, input to the voice generation unit, and storage in the article database. As a technical effect, the translation unit automatically optimizes translation length according to the user's emotional state, greatly improving user experience, information transmission efficiency, and stress reduction compared to conventional uniform translation generation. In particular, by combining emotion estimation in high-dimensional feature space and translation length control, the AI achieves non-conventional processing procedures different from human simple summarization or sequential translation, bringing significant technical improvements in terms of computational efficiency, accuracy, and operational cost. Application fields include personalized translation for international news distribution, educational information provision, multilingual information transmission support in medical and welfare fields, and voice news for visually impaired users.

The translation unit can determine the priority of translation based on the publication timing of the article during translation. The translation unit determines the priority of translation based on the publication timing of the article during translation. For example, the translation unit evaluates the publication timing of the article using generative AI. The generative AI analyzes data such as the publication date of the article and the elapsed time since publication to evaluate the publication timing. The translation unit determines the priority of translation based on the publication timing of the article. For example, the latest articles are prioritized for translation generation. Past articles have their translation priority adjusted according to their importance. Furthermore, articles related to specific periods are prioritized for translation generation. This enables the priority of translation to be adjusted according to the publication timing of the article. Specifically, the translation unit receives as input the article body (up to 4096 tokens), article publication date (UNIX timestamp or ISO8601 format), current time, article category, and article importance score. The AI calculates the elapsed time (in minutes, hours, days) from the difference between the publication date and the current time and computes a recency score (0.0 to 1.0). Example inputs to the AI include an article body published on Jun. 1, 2024, current time (Jun. 2, 2024), category (technology), and importance score (0.92). Example outputs from the AI include recency score (0.98), translation priority (high), and translation generation trigger flag (True). The translation unit prioritizes articles with high recency scores in the translation generation queue, and adjusts the priority of past articles according to their importance or user requests. Articles related to specific periods (e.g., during disasters or events) have their priority increased by a period determination algorithm. These outputs are used for subsequent processing such as display of new article translations in the user interface, input to the voice generation unit and article database, and push notifications. As a technical effect, the translation unit automatically controls the priority of translation generation according to the publication timing of the article, enabling users to quickly obtain the latest and most important information, and greatly improving the immediacy of information transmission, overall system resource optimization, and user satisfaction. Application fields include breaking news distribution, multilingual transmission of disaster information, event news translation, and timely translation generation for internal corporate information sharing.

The translation unit can adjust the order of translation based on the relevance of the article during translation. The translation unit adjusts the order of translation based on the relevance of the article during translation. For example, the translation unit evaluates the relevance of articles using generative AI. The generative AI analyzes data such as content similarity and topic commonality to evaluate article relevance. The translation unit adjusts the order of translation based on the relevance of the article. For example, articles with high relevance are prioritized for translation generation. Articles with low relevance are generated later. Furthermore, articles with moderate relevance are generated in an appropriate order. This enables the order of translation to be adjusted according to the relevance of the article. Specifically, the translation unit receives as input multiple article bodies (each up to 4096 tokens), article titles, article categories, and article metadata (publication date, author, etc.), and calculates semantic similarity scores (0.0 to 1.0) between articles using BERT-based semantic vector generation models or topic modeling algorithms (e.g., LDA, Doc2Vec). Example inputs to the AI include article A “New AI technology announced,” article B “Social impact of AI technology,” and article C “Sports event results,” including their bodies and titles. Example outputs from the AI include relevance score between A and B (0.87), relevance score between A and C (0.12), and related group ID (AI technology group). The translation unit groups articles with high relevance scores and dynamically adjusts the order of the translation generation queue. For example, consecutive articles on the same topic are collectively translated and displayed consecutively to the user. Articles with low relevance are delayed for translation generation as needed. These outputs are used for subsequent processing such as display of related article translations in the user interface, topic classification in the voice generation unit and article database, and push notifications. As a technical effect, the translation unit controls the order of translation based on article relevance, enabling users to efficiently grasp topics of high interest, and greatly improving information search efficiency, user satisfaction, and overall system information organization. Application fields include display of related article translations in international news distribution services, topic-based translation for internal corporate information sharing, theme-based translation for educational materials, and integration of related information in multiple languages during disasters.

The system according to the embodiment is not limited to the examples described above and can be variously modified as follows, for example. Specifically, the system allows for diverse variations in AI model architecture, data flow, input/output specifications, user interface design, database configuration, communication protocols, security mechanisms, and addition of extension modules. For example, each AI module such as the summarization unit, answering unit, voice generation unit, translation unit, and reporting unit can select different AI architectures such as Transformer-based large language models, convolutional neural networks, recurrent neural networks, gradient boosting decision trees, and rule-based classifiers. The input data formats for AI can also be combined and used, including text arrays, image tensors, voice waveforms, numerical vectors, time-series data, and metadata. The outputs from AI can generate diverse structured data such as summary texts, answer texts, translation texts, voice waveforms, confidence scores, cluster IDs, and priority labels. Furthermore, depending on user attributes and usage environment, various operational forms such as personalized control, accessibility functions, real-time processing, batch processing, distributed processing, cloud integration, and edge AI implementation can be adopted. These modifications can be flexibly applied to maximize the technical effects of the system (e.g., improved processing speed, improved accuracy, reduced operational costs, enhanced information transmission efficiency, improved user experience, etc.), and demonstrate high technical utility in various fields such as news distribution services, educational information provision, internal corporate information sharing, multilingual information transmission during disasters, and voice news for visually impaired users.

The news customization system can estimate the user's interests and adjust the display order of articles based on the estimated interests. For example, the news customization system analyzes the user's past browsing history and search history to estimate the user's interests. Based on the estimated interests, the news customization system prioritizes the display of articles that the user is likely to be interested in. Furthermore, if the user shows interest in a specific topic, articles related to that topic are prioritized for display. Additionally, if the user's interests change, the news customization system can adjust the display order in real time. This enables articles to be displayed according to the user's interests. Specifically, the news customization system receives as input the user's browsing history (e.g., time-series array of article IDs), search history (e.g., text array of search queries), click patterns (e.g., pairs of article IDs and click times), and article category information (e.g., politics, economy, sports, etc.), and calculates an interest vector for each user (score array for each category, e.g., a real-valued vector of length 10) using an interest estimation AI (e.g., multilayer perceptron, recurrent neural network, collaborative filtering model, etc.). Example inputs to the AI include browsing article ID array for the past 30 days ([123, 456, 789]), search queries (“AI technology,” “economic news”), and click history ([123, 20240601T120000]). Example outputs from the AI include interest category scores (“technology: 0.92,” “economy: 0.85”), estimation confidence (0.95), and prioritized article ID list ([456, 789, 123]). The system prioritizes articles in categories with high interest scores in the display queue and recalculates the display order in real time when changes in user behavior (e.g., interest in a new category) are detected. These outputs are used for subsequent processing such as article list display in the user interface, push notifications, and input to the recommendation engine. As a technical effect, the system achieves significant improvements in user experience, information search efficiency, click-through rate, dwell time, and satisfaction compared to conventional uniform article distribution or manual sorting, through dynamic display order control by user interest estimation AI. Application fields include personalized display in news distribution services, educational information provision, internal corporate information sharing, and timeline optimization in SNS.

The news customization system can collect user feedback and improve the content of articles based on the feedback. For example, the news customization system provides an interface for users to leave ratings and comments on articles. User feedback is collected and stored in a database. Based on the collected feedback, the news customization system executes algorithms to improve the content of articles. For example, if a user expresses dissatisfaction with the content of an article, the content is corrected. If a user requests specific information, that information is added. This enables articles to be improved based on user feedback. Specifically, the news customization system receives as input user ratings (e.g., 5-point rating score), comment text (up to 512 tokens), feedback time, and article ID, and automatically generates classification of feedback content (e.g., dissatisfaction, request, approval), importance score (0.0 to 1.0), and correction proposals (e.g., misinformation correction, information addition, expression improvement) using a feedback analysis AI (e.g., natural language processing model+clustering algorithm). Example inputs to the AI include rating score (2), comment (“Information is insufficient”), and article ID (12345). Example outputs from the AI include classification label (“request”), importance (0.85), and correction proposal (“Additional information: describe application examples of AI technology”). The system triggers article correction algorithms in order of feedback with high importance, and correction proposals are either reviewed by administrators or automatically reflected. These outputs are used for subsequent processing such as updating article database content, user notifications, and quality management reports. As a technical effect, the system achieves significant improvements in article quality, user satisfaction, information transmission efficiency, and operational costs compared to conventional manual editing or simple survey aggregation, through AI-based feedback analysis and automated content improvement. Application fields include quality management in news distribution services, content optimization in educational materials, improvement cycles in internal corporate information sharing, and post quality improvement in SNS.

The news customization system can estimate the user's emotion and adjust the display method of articles based on the estimated emotion. For example, the news customization system estimates the user's emotion using an emotion engine or generative AI. The emotion engine analyzes data such as the user's facial expressions and voice to estimate emotion. The generative AI adjusts the display method of articles based on the user's emotion. For example, if the user is feeling stressed, the news customization system displays articles in a calm tone. If the user is relaxed, the news customization system displays articles in a relaxed tone. Furthermore, if the user is in a hurry, the news customization system emphasizes only the most important points in the display. This enables the display method of articles to be adjusted according to the user's emotion. Specifically, the news customization system inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., stress, relaxation, hurry) and emotion intensity scores (0.0 to 1.0). Example inputs to the AI include a confused facial image, tense voice waveform, and short comment such as “I'm in a hurry.” Example outputs from the AI include emotion label (“stress”), emotion intensity (0.82), and estimation confidence (0.91). The system dynamically adjusts the article display style on the user interface (e.g., background color, font, emphasis, display order, etc.) based on the emotion estimation results. For example, in cases of stress, a calm color scheme and concise layout are applied; in cases of relaxation, a soft color scheme and detailed display are used; and in cases of hurry, a layout emphasizing only the main points is applied. These outputs are used for subsequent processing such as user interface display, input to the voice generation unit, and storage in the article database. As a technical effect, the system automatically optimizes the display method of articles according to the user's emotional state, greatly improving user experience, information transmission efficiency, and stress reduction compared to conventional uniform display or manual adjustment. Application fields include personalized display in news distribution services, educational information provision, information transmission support in medical and welfare fields, and voice news for visually impaired users.

The news customization system can analyze user behavior patterns and recommend articles based on the analysis results. For example, the news customization system analyzes the user's past browsing history, search history, and click patterns. Based on the analysis results, the system recommends articles that the user is likely to be interested in. Furthermore, if the user shows interest in a specific topic during a specific time period, the system recommends articles related to that time period. Additionally, if the user's behavior patterns change, the news customization system can adjust the recommendations in real time. This enables article recommendations according to user behavior patterns. Specifically, the news customization system receives as input the user's browsing history (time-series array of article IDs), search history (text array of search queries), click patterns (pairs of article IDs and click times), access time periods (time data), and article category information, and calculates user-specific behavior feature vectors and time-based interest scores using a behavior pattern analysis AI (e.g., recurrent neural network, time-series clustering model, collaborative filtering, etc.). Example inputs to the AI include browsing article ID array for the past 30 days, search queries (“AI technology,” “economic news”), click history ([123, 20240601T120000]), and access time (18:00). Example outputs from the AI include time-based interest scores (“18:00: technology 0.92”), recommended article ID list ([456, 789, 123]), and estimation confidence (0.95). The system detects changes in behavior patterns (e.g., interest in a new category, shift in access time) and recalculates recommendations in real time to present optimal articles to the user. These outputs are used for subsequent processing such as recommendation display in the user interface, push notifications, and input to the article database. As a technical effect, the system achieves significant improvements in user experience, information search efficiency, click-through rate, dwell time, and satisfaction compared to conventional static recommendations or manual analysis, through AI-based behavior pattern analysis and automated recommendations. Application fields include personalized recommendations in news distribution services, educational information provision, internal corporate information sharing, and timeline optimization in SNS.

The news customization system can estimate the user's emotion and adjust the content of articles based on the estimated emotion. For example, the news customization system estimates the user's emotion using an emotion engine or generative AI. The emotion engine analyzes data such as the user's facial expressions and voice to estimate emotion. The generative AI adjusts the content of articles based on the user's emotion. For example, if the user is feeling stressed, the news customization system emphasizes positive content. If the user is relaxed, the system provides detailed content. Furthermore, if the user is in a hurry, the system provides short content containing only the most important points. This enables the content of articles to be adjusted according to the user's emotion. Specifically, the news customization system inputs facial images (224×224×3 pixel RGB images), voice waveform data (16 kHz, 16 bit PCM, 3 seconds), and user input text (up to 256 tokens) to an emotion recognition AI for emotion estimation. The emotion recognition AI uses CNN or RNN-based image and voice encoders to output emotion labels (e.g., stress, relaxation, hurry) and emotion intensity scores (0.0 to 1.0). Example inputs to the AI include a confused facial image, tense voice waveform, and short comment such as “I'm in a hurry.” Example outputs from the AI include emotion label (“stress”), emotion intensity (0.82), and estimation confidence (0.91). The system dynamically switches the decoder parameters and output templates of the article generation AI (e.g., Transformer-based large language model) based on the emotion estimation results. For example, in cases of stress, positive content and concise key points are emphasized; in cases of relaxation, detailed explanations and background information are added; and in cases of hurry, short content containing only the most important points is generated. These outputs are used for subsequent processing such as user interface display, input to the voice generation unit, and storage in the article database. As a technical effect, the system automatically optimizes article content according to the user's emotional state, greatly improving user experience, information transmission efficiency, and stress reduction compared to conventional uniform article generation or manual adjustment. Application fields include personalized content generation in news distribution services, educational information provision, information transmission support in medical and welfare fields, and voice news for visually impaired users.

The news customization system can acquire the user's location information and preferentially display local news based on the location information. For example, the news customization system acquires location information from the user's device. Based on the acquired location information, news from the region where the user is currently located is preferentially displayed. Furthermore, if the user shows interest in a specific region, news related to that region is preferentially displayed. Additionally, when the user is traveling, news from the travel destination can be preferentially displayed. This enables the display of local news according to the user's location information. Specifically, the news customization system acquires GPS coordinates (latitude and longitude as floating-point values), location acquisition time, location accuracy information, etc., from the user device, and determines the user's current location and regions of interest using a location information analysis AI (e.g., geocoding model, regional clustering algorithm). Examples of AI input include GPS coordinates (35.6895, 139.6917), location acquisition time (20240601T120000), and past location history (up to 30 entries). Examples of AI output include current location label (“Chiyoda-ku, Tokyo”), region of interest score (“Osaka: 0.85”), and prioritized article ID list ([456, 789, 123]). The system preferentially adds news articles related to the current location or regions of interest to the display queue, and automatically detects and prioritizes news from travel destinations when the user is traveling. These outputs are used for subsequent processing such as local news display on the user interface, push notifications, and input to the article database. As a technical effect, the system achieves significant improvements in user experience, information search efficiency, regional relevance, and satisfaction compared to conventional uniform article distribution and manual region determination, by dynamically controlling local news display using location information analysis AI. Application fields include regional optimization of news distribution services, region-specific information transmission during disasters, provision of tourism information, and sharing of local information within companies.

The news customization system can estimate the user's emotion and adjust the article format based on the estimated emotion. For example, the news customization system estimates the user's emotion using an emotion engine or generative AI. The emotion engine analyzes data such as the user's facial expressions and voice to estimate emotion. The generative AI adjusts the article format based on the user's emotion. For instance, if the user is feeling stressed, the news customization system provides a concise and visually easy-to-understand format. If the user is relaxed, the system provides a detailed and readable format. Furthermore, if the user is in a hurry, the system provides a format that emphasizes only the most important points. This enables adjustment of the article format according to the user's emotion. Specifically, the news customization system inputs facial images (224×224×3 pixel RGB images), voice waveform data (16 kHz, 16 bit PCM, 3 seconds), and user input text (up to 256 tokens) into an emotion recognition AI for emotion estimation. The emotion recognition AI uses CNN or RNN-based image and voice encoders to output emotion labels (e.g., stress, relaxation, hurry) and emotion intensity scores (0.0-1.0). Examples of AI input include a user's confused facial image, tense voice waveform, and short comments such as “I'm in a hurry.” Examples of AI output include emotion label (“stress”), emotion intensity (0.82), and estimated confidence (0.91). Based on the emotion estimation results, the system dynamically switches article generation AI output templates and layout parameters (e.g., font size, color, paragraph structure, presence/absence of charts and tables). For example, during stress, a format with large headlines, icons, and bullet points is applied; during relaxation, a readable format with detailed paragraphs and many charts/tables is used; and in a hurry, a simple layout emphasizing only key points is applied. These outputs are used for subsequent processing such as user interface display, input to the voice generation unit, and saving to the article database. As a technical effect, the system automatically optimizes article format according to the user's emotional state, greatly improving user experience, information transmission efficiency, and stress reduction compared to conventional uniform layouts and manual adjustments. Application fields include personalized display in news distribution services, educational information provision, information transmission support in medical and welfare fields, and voice news for visually impaired users.

The news customization system can adjust the article display method according to the type of user device. For example, the news customization system detects the device used by the user and provides the optimal display method for that device. When a smartphone is used, the system provides a mobile-friendly display method. When a tablet is used, the system provides a display method optimized for a large screen. Furthermore, when a desktop is used, the system provides a layout for displaying detailed information. This enables adjustment of the article display method according to the user's device. Specifically, the news customization system automatically detects the type of user device (e.g., smartphone, tablet, desktop), screen resolution, OS type, browser information, etc., and determines the optimal display template and layout parameters (e.g., font size, number of columns, image size, interaction method) using a device characteristic analysis AI (e.g., rule-based classifier, decision tree model). Examples of AI input include device type (“smartphone”), screen resolution (1080×1920), OS (“Android”), and browser (“Chrome”). Examples of AI output include display template ID (“mobile_v2”), recommended font size (18 pt), image size (small), and number of columns (1). The system automatically applies a mobile-friendly vertical scroll layout for smartphones, a two-column display for large screens, and a detailed information layout for desktops according to the device type. These outputs are used for subsequent processing such as user interface display, input to the voice generation unit, and saving to the article database. As a technical effect, the system achieves significant improvements in user experience, information transmission efficiency, accessibility, and satisfaction compared to conventional uniform layouts and manual adjustments, by dynamically controlling the display method using device characteristic analysis AI. Application fields include multi-device support for news distribution services, educational information provision, internal company information sharing, and voice news for visually impaired users.

The news customization system can estimate the user's emotion and adjust the article delivery timing based on the estimated emotion. For example, the news customization system estimates the user's emotion using an emotion engine or generative AI. The emotion engine analyzes data such as the user's facial expressions and voice to estimate emotion. The generative AI adjusts the article delivery timing based on the user's emotion. For instance, if the user is feeling stressed, the news customization system delivers articles during times when the user can relax. If the user is relaxed, the system delivers articles at any time. Furthermore, if the user is in a hurry, the system quickly delivers the most important articles. This enables adjustment of article delivery timing according to the user's emotion. Specifically, the news customization system inputs facial images (224×224×3 pixel RGB images), voice waveform data (16 kHz, 16 bit PCM, 3 seconds), and user input text (up to 256 tokens) into an emotion recognition AI for emotion estimation. The emotion recognition AI uses CNN or RNN-based image and voice encoders to output emotion labels (e.g., stress, relaxation, hurry) and emotion intensity scores (0.0-1.0). Examples of AI input include a user's confused facial image, tense voice waveform, and short comments such as “I'm in a hurry.” Examples of AI output include emotion label (“stress”), emotion intensity (0.82), and estimated confidence (0.91). Based on the emotion estimation results, the delivery timing control module dynamically adjusts the parameters of the article delivery scheduler (e.g., delivery time, priority, notification frequency). For example, during stress, the system refers to the user's calendar and past relaxation time slots to deliver articles during those times; during relaxation, articles are delivered immediately; and in a hurry, the most important articles are preferentially pushed. These outputs are used for subsequent processing such as notifications to user devices, recording delivery in the article database, and delivery log analysis. As a technical effect, the system automatically optimizes article delivery timing according to the user's emotional state, greatly improving user experience, information transmission efficiency, stress reduction, and notification effectiveness compared to conventional uniform delivery and manual adjustments. Application fields include personalized delivery in news distribution services, educational information provision, information transmission support in medical and welfare fields, and voice news for visually impaired users.

The news customization system can analyze the user's subscription history and recommend articles based on the subscription history. For example, the news customization system analyzes the history of articles the user has subscribed to in the past. Based on the analysis results, articles that the user is likely to be interested in are recommended. Furthermore, if the user frequently subscribes to articles on a specific topic, articles related to that topic are preferentially recommended. Additionally, when the user's subscription history changes, the news customization system can adjust the recommendations in real time. This enables recommendation of articles according to the user's subscription history. Specifically, the news customization system inputs the user's subscription history (time series array of article IDs), subscription dates, article category information, etc., into a subscription history analysis AI (e.g., recurrent neural network, collaborative filtering model) to calculate interest vectors for each user and topic-specific subscription scores. Examples of AI input include an array of subscribed article IDs over the past 30 days ([123, 456, 789]), subscription date (20240601), and category (“technology”). Examples of AI output include topic-specific subscription scores (“technology: 0.92”, “economy: 0.85”), recommended article ID list ([456, 789, 123]), and estimated confidence (0.95). The system preferentially recommends articles in categories with high subscription scores, and when changes in subscription history (e.g., interest in new categories) are detected, the recommendations are recalculated in real time. These outputs are used for subsequent processing such as displaying recommendations on the user interface, push notifications, and input to the article database. As a technical effect, the system achieves significant improvements in user experience, information search efficiency, click-through rate, dwell time, and satisfaction compared to conventional static recommendations and manual analysis, by dynamically controlling recommendations using subscription history analysis AI. Application fields include personalized recommendations in news distribution services, educational information provision, internal company information sharing, and timeline optimization in social networking services.

Below, the processing flow of Example of the Embodiment is briefly described. Specifically, the system realizes a series of data flows from article acquisition to summary generation, question answering, voice conversion, translation, headline optimization, and user feedback processing, through cooperation among multiple AI modules, databases, user interfaces, communication modules, and others. At each step, the input data format for AI (e.g., token array of article text, user question text, image tensor, audio waveform, metadata), output data from AI (e.g., summary text, answer text, audio waveform, translation text, headline revision proposal), and subsequent processing (e.g., display, audio playback, database update, notification) are clearly defined. As a result, the system as a whole achieves high-precision, high-speed, and low-load information provision and optimization of user experience.

Step 1: The summarization unit analyzes the content of an article, extracts important points, and generates a summary. For example, the summarization unit analyzes the content of an article using generative AI, extracts important points, and generates a summary. The generative AI uses a text generation AI (for example, LLM) to concisely summarize the article. The summarization unit can also use multimodal generative AI to summarize the content of the article. For example, the generative AI uses keyword extraction technology to pick up particularly important information in the article and generates a summary based on that. Step 2: The answering unit answers a user's question based on the summary generated by the summarization unit. For example, the answering unit generates an appropriate answer to the user's question using generative AI. The generative AI analyzes the user's question using natural language processing technology and generates an answer based on the content of the article. Step 3: The voice generation unit converts the article into speech based on the answer generated by the answering unit. For example, the voice generation unit analyzes the content of the article using generative AI and reads it aloud in a natural voice. The generative AI uses speech synthesis technology to convert the content of the article into speech. Specifically, in Step 1, the system uses a Transformer-based large language model as the summarization unit, receiving as input a token sequence of the article text (up to 4096 tokens of Japanese text array), pixel array of attached images (224×224×3), and article metadata (publication date, category, etc.). The summarization unit extracts contextually important words and phrases using a self-attention mechanism and generates as output a summary text (e.g., “New AI technology announced at international conference”), a list of important keywords, and a summary score. In Step 2, the answering unit receives as input a natural language question from the user (up to 256 tokens), the summary text, and the article text, performs semantic analysis of the question using a BERT-series encoder, calculates semantic relevance with the article summary, and generates the optimal answer text (e.g., “The new technology has twice the inference speed compared to conventional methods”), and an answer confidence score. In Step 3, the voice generation unit receives as input the output text from the answering unit and the user's desired voice tone (e.g., “calm voice”), and uses deep neural network-based speech synthesis models such as WaveNet or Tacotron2 to generate natural audio waveforms (16 kHz, 16 bit PCM data), audio length, and audio quality score. These outputs are used for subsequent processing such as user interface display, audio playback, article database update, and push notifications to users. As a technical effect, the system automates high-precision summarization, answering, and voice conversion by AI, enabling optimal information provision for each user quickly and with low load, and greatly improving information acquisition efficiency, user satisfaction, and system operation cost compared to conventional manual editing and simple automatic distribution. Specific application fields include news distribution services, educational information provision, internal company information sharing, multilingual information transmission during disasters, and voice news provision for visually impaired users.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned summarization unit, answering unit, voice generation unit, reporting unit, and translation unit is implemented by at least one of, for example, the smart device 14 and the data processing apparatus 12. For example, the summarization unit is implemented by the control unit 46A of the smart device 14 or the specific processing unit 290 of the data processing apparatus 12. The answering unit is implemented, for example, by the specific processing unit 290 of the data processing apparatus 12 and generates an appropriate answer to the user's question. The voice generation unit is implemented, for example, by the control unit 46A of the smart device 14 or the specific processing unit 290 of the data processing apparatus 12 and reads out the article in natural speech. The reporting unit is implemented, for example, by the control unit 46A of the smart device 14 or the specific processing unit 290 of the data processing apparatus 12 and provides an interface for the user to report clickbait headline articles. The translation unit is implemented, for example, by the specific processing unit 290 of the data processing apparatus 12 and performs translation and speech conversion of foreign articles. The correspondence between each unit and the device or control unit is not limited to the examples described above and various modifications are possible.

### Second Embodiment

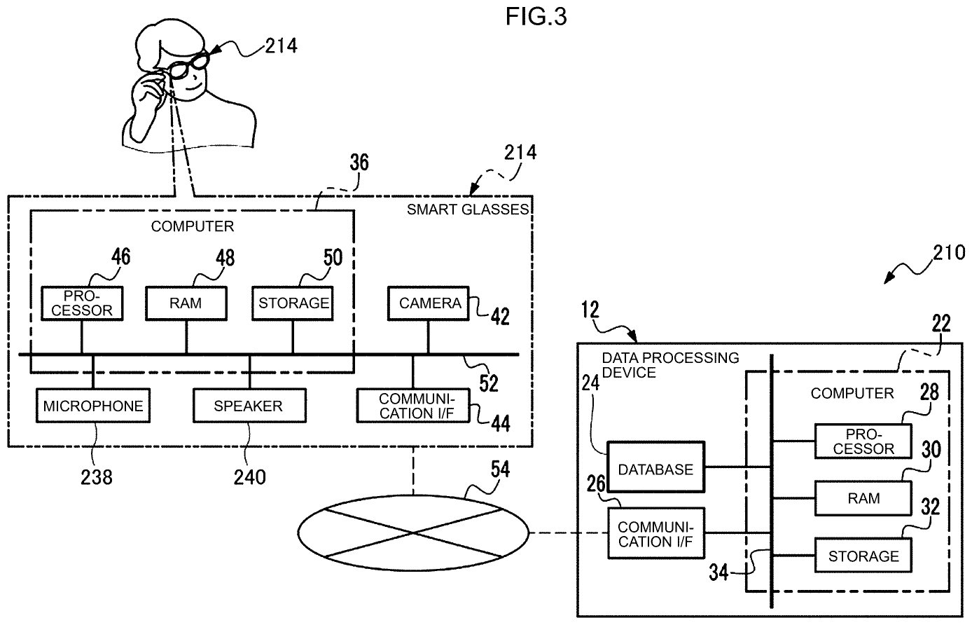

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

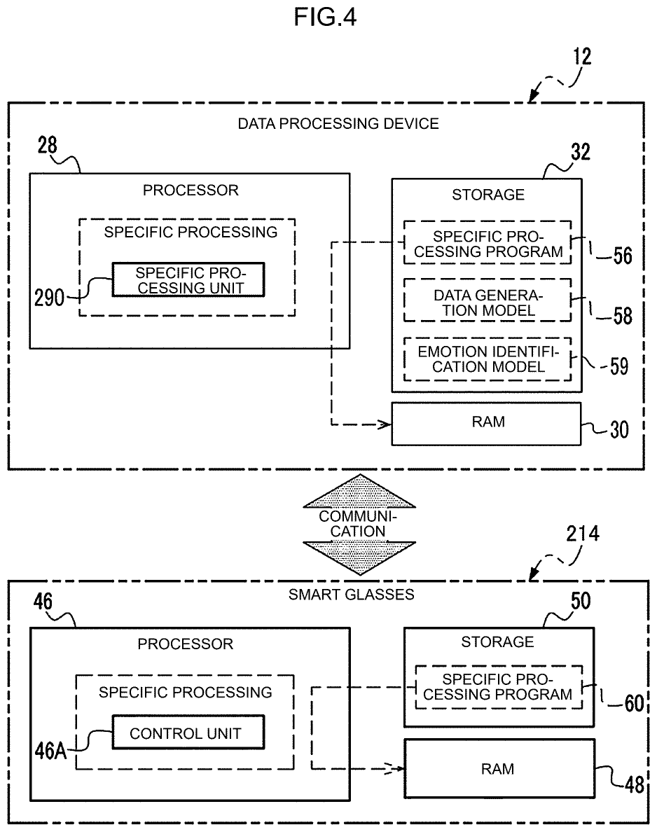

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned summarization unit, answering unit, voice generation unit, reporting unit, and translation unit is implemented by at least one of, for example, the smart glasses 214 and the data processing apparatus 12. For example, the summarization unit is implemented by the control unit 46A of the smart glasses 214 or the specific processing unit 290 of the data processing apparatus 12. The answering unit is implemented, for example, by the specific processing unit 290 of the data processing apparatus 12 and generates an appropriate answer to the user's question. The voice generation unit is implemented, for example, by the control unit 46A of the smart glasses 214 or the specific processing unit 290 of the data processing apparatus 12 and reads out the article in natural speech. The reporting unit is implemented, for example, by the control unit 46A of the smart glasses 214 or the specific processing unit 290 of the data processing apparatus 12 and provides an interface for the user to report clickbait headline articles. The translation unit is implemented, for example, by the specific processing unit 290 of the data processing apparatus 12 and performs translation and speech conversion of foreign articles. The correspondence between each unit and the device or control unit is not limited to the examples described above and various modifications are possible.

### Third Embodiment

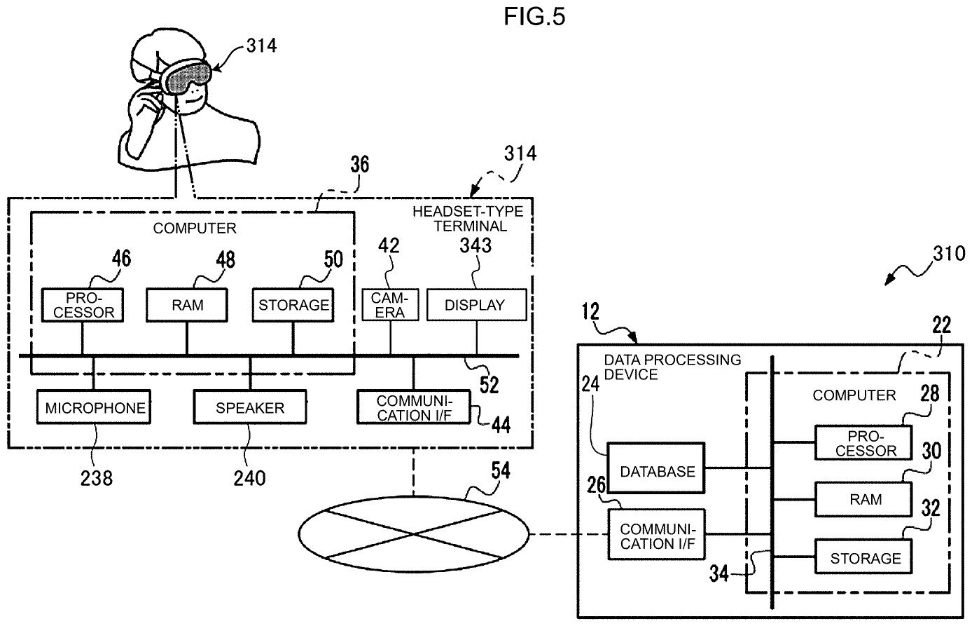

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

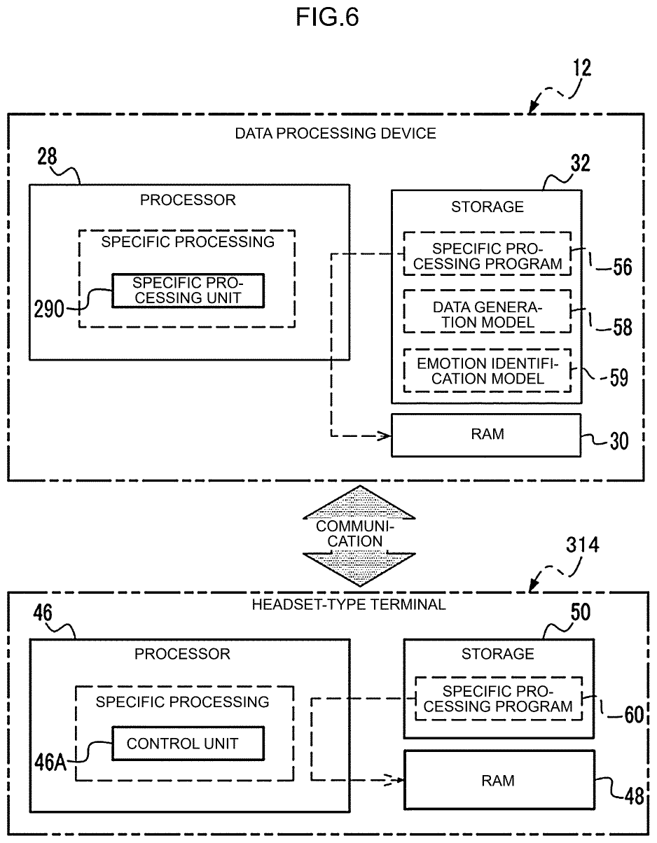

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned summarization unit, answering unit, voice generation unit, reporting unit, and translation unit is implemented by at least one of, for example, the headset-type terminal 314 and the data processing apparatus 12. For example, the summarization unit is implemented by the control unit 46A of the headset-type terminal 314 or the specific processing unit 290 of the data processing apparatus 12. The answering unit is implemented, for example, by the specific processing unit 290 of the data processing apparatus 12 and generates an appropriate answer to the user's question. The voice generation unit is implemented, for example, by the control unit 46A of the headset-type terminal 314 or the specific processing unit 290 of the data processing apparatus 12 and reads out the article in natural speech. The reporting unit is implemented, for example, by the control unit 46A of the headset-type terminal 314 or the specific processing unit 290 of the data processing apparatus 12 and provides an interface for the user to report clickbait headline articles. The translation unit is implemented, for example, by the specific processing unit 290 of the data processing apparatus 12 and performs translation and speech conversion of foreign articles. The correspondence between each unit and the device or control unit is not limited to the examples described above and various modifications are possible.

### Fourth Embodiment

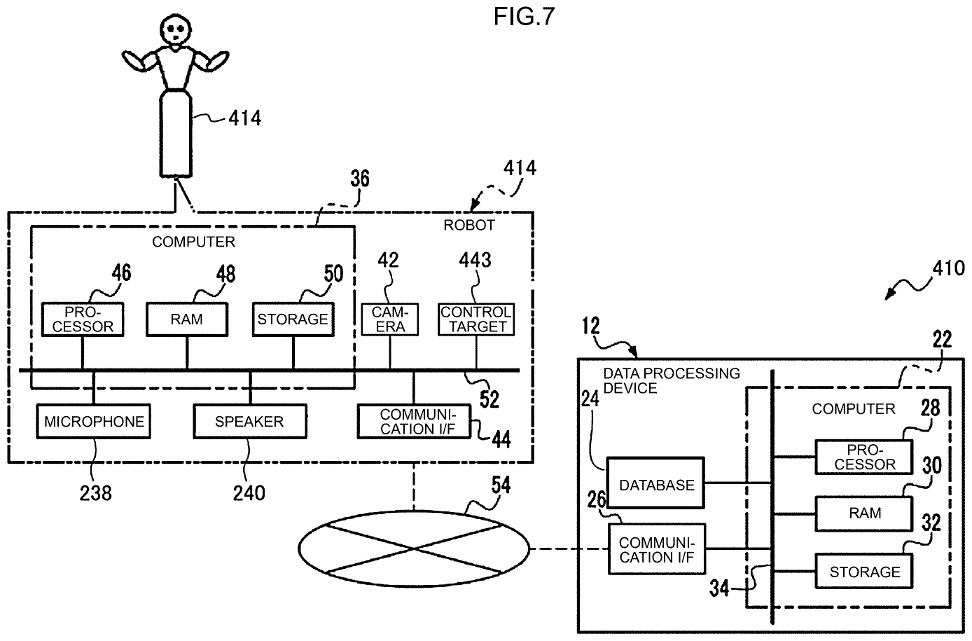

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

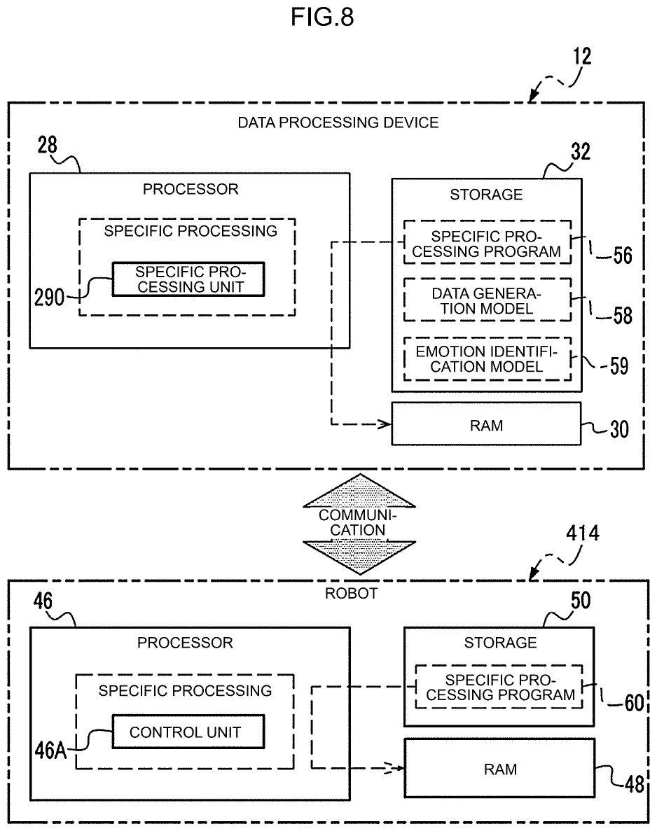

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned summarization unit, answering unit, voice generation unit, reporting unit, and translation unit is implemented by at least one of, for example, the robot 414 and the data processing apparatus 12. For example, the summarization unit is implemented by the control unit 46A of the robot 414 or the specific processing unit 290 of the data processing apparatus 12. The answering unit is implemented, for example, by the specific processing unit 290 of the data processing apparatus 12 and generates an appropriate answer to the user's question. The voice generation unit is implemented, for example, by the control unit 46A of the robot 414 or the specific processing unit 290 of the data processing apparatus 12 and reads out the article in natural speech. The reporting unit is implemented, for example, by the control unit 46A of the robot 414 or the specific processing unit 290 of the data processing apparatus 12 and provides an interface for the user to report clickbait headline articles. The translation unit is implemented, for example, by the specific processing unit 290 of the data processing apparatus 12 and performs translation and speech conversion of foreign articles. The correspondence between each unit and the device or control unit is not limited to the examples described above and various modifications are possible.

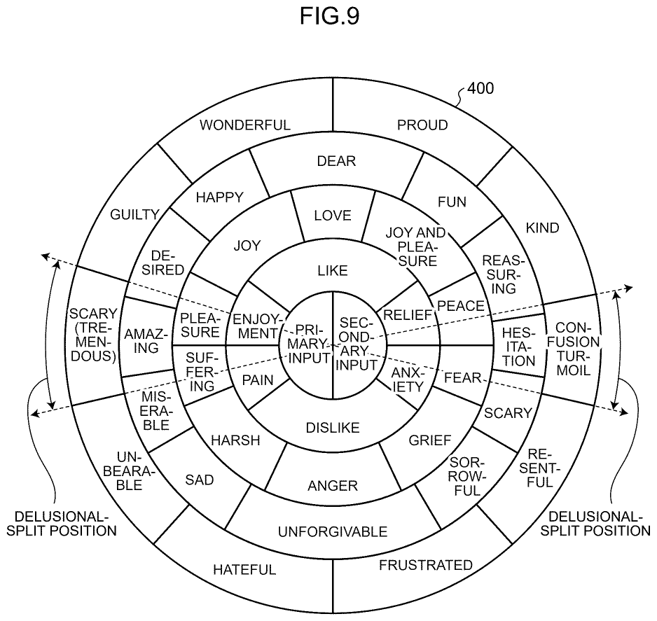

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

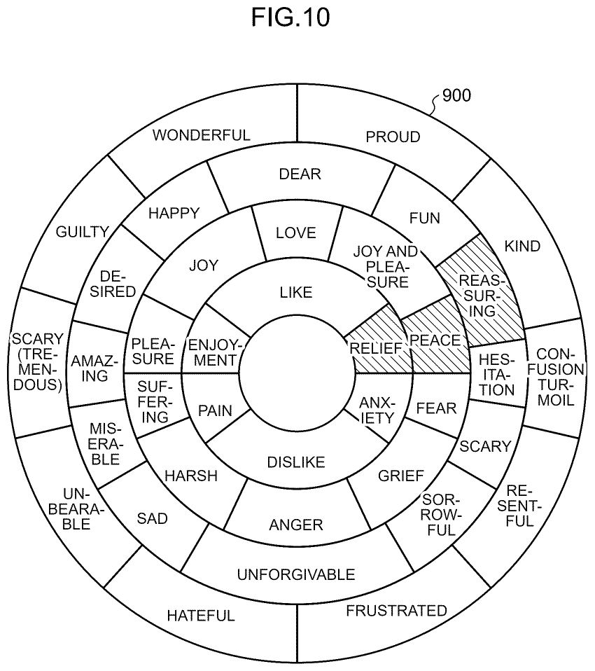

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a summarization unit configured to analyze the content of an article, extract important points, and generate a summary; an answering unit configured to answer a user's question based on the summary generated by the summarization unit; and a voice generation unit configured to convert the article into speech based on the answer generated by the answering unit.
(Supplementary Note 2) The system according to Supplementary Note 1, further comprising a reporting unit configured to report clickbait headline articles.
(Supplementary Note 3) The system according to Supplementary Note 2, wherein the reporting unit is configured to collect user reports and automatically optimize the headline if there are multiple reports.
(Supplementary Note 4) The system according to Supplementary Note 1, further comprising a translation unit configured to collectively translate and convert foreign articles into speech.
(Supplementary Note 5) The system according to Supplementary Note 4, wherein the translation unit is configured to analyze the content of the article using generative AI and perform translation and speech conversion.
(Supplementary Note 6) The system according to Supplementary Note 1, wherein the summarization unit is configured to estimate the user's emotion and adjust the expression method of the summary based on the estimated emotion.
(Supplementary Note 7) The system according to Supplementary Note 1, wherein the summarization unit is configured to adjust the level of detail of the summary during summary generation based on the importance of the article.
(Supplementary Note 8) The system according to Supplementary Note 1, wherein the summarization unit is configured to apply different summarization algorithms during summary generation according to the category of the article.
(Supplementary Note 9) The system according to Supplementary Note 1, wherein the summarization unit is configured to estimate the user's emotion and adjust the length of the summary based on the estimated emotion.
(Supplementary Note 10) The system according to Supplementary Note 1, wherein the summarization unit is configured to determine the priority of the summary during summary generation based on the publication timing of the article.
(Supplementary Note 11) The system according to Supplementary Note 1, wherein the summarization unit is configured to adjust the order of the summary during summary generation based on the relevance of the article.
(Supplementary Note 12) The system according to Supplementary Note 1, wherein the answering unit is configured to estimate the user's emotion and adjust the expression method of the answer based on the estimated emotion.
(Supplementary Note 13) The system according to Supplementary Note 1, wherein the answering unit is configured to adjust the level of detail of the answer during answer generation based on the importance of the question.
(Supplementary Note 14) The system according to Supplementary Note 1, wherein the answering unit is configured to apply different answer algorithms during answer generation according to the category of the question.
(Supplementary Note 15) The system according to Supplementary Note 1, wherein the answering unit is configured to estimate the user's emotion and adjust the length of the answer based on the estimated emotion.
(Supplementary Note 16) The system according to Supplementary Note 1, wherein the answering unit is configured to determine the priority of the answer during answer generation based on the submission timing of the question.
(Supplementary Note 17) The system according to Supplementary Note 1, wherein the answering unit is configured to adjust the order of the answer during answer generation based on the relevance of the question.
(Supplementary Note 18) The system according to Supplementary Note 1, wherein the voice generation unit is configured to estimate the user's emotion and adjust the tone and speed of the speech based on the estimated emotion.
(Supplementary Note 19) The system according to Supplementary Note 1, wherein the voice generation unit is configured to adjust the level of detail of the speech during speech conversion based on the importance of the article.
(Supplementary Note 20) The system according to Supplementary Note 1, wherein the voice generation unit is configured to apply different speech algorithms during speech conversion according to the category of the article.
(Supplementary Note 21) The system according to Supplementary Note 1, wherein the voice generation unit is configured to estimate the user's emotion and adjust the length of the speech based on the estimated emotion.
(Supplementary Note 22) The system according to Supplementary Note 1, wherein the voice generation unit is configured to determine the priority of the speech during speech conversion based on the publication timing of the article.
(Supplementary Note 23) The system according to Supplementary Note 1, wherein the voice generation unit is configured to adjust the order of the speech during speech conversion based on the relevance of the article.
(Supplementary Note 24) The system according to Supplementary Note 2, wherein the reporting unit is configured to estimate the user's emotion and determine the priority of the report based on the estimated emotion.
(Supplementary Note 25) The system according to Supplementary Note 2, wherein the reporting unit is configured to refer to past report data during reporting and improve the accuracy of the report.
(Supplementary Note 26) The system according to Supplementary Note 2, wherein the reporting unit is configured to estimate the user's emotion and adjust the display method of the report based on the estimated emotion.
(Supplementary Note 27) The system according to Supplementary Note 4, wherein the translation unit is configured to estimate the user's emotion and adjust the expression method of the translation based on the estimated emotion.
(Supplementary Note 28) The system according to Supplementary Note 4, wherein the translation unit is configured to adjust the level of detail of the translation during translation based on the importance of the article.
(Supplementary Note 29) The system according to Supplementary Note 4, wherein the translation unit is configured to apply different translation algorithms during translation according to the category of the article.
(Supplementary Note 30) The system according to Supplementary Note 4, wherein the translation unit is configured to estimate the user's emotion and adjust the length of the translation based on the estimated emotion.
(Supplementary Note 31) The system according to Supplementary Note 4, wherein the translation unit is configured to determine the priority of the translation during translation based on the publication timing of the article.
(Supplementary Note 32) The system according to Supplementary Note 4, wherein the translation unit is configured to adjust the order of the translation during translation based on the relevance of the article.

What is claimed is:

1. A system comprising:
circuitry configured to:
receive first data comprising a sequence of tokens;
generate a first feature vector by inputting the sequence of tokens into a first neural network, the first neural network comprising a transformer architecture configured to apply a self-attention mechanism to the sequence of tokens;
receive second data comprising a query sequence;
generate a second feature vector by inputting the query sequence and the first feature vector into a second neural network configured to compute a semantic relevance score between the query sequence and the first feature vector; and
generate waveform data by inputting at least one of the first feature vector or the second feature vector into a speech synthesis neural network.

2. The system according to claim 1, wherein the circuitry is further configured to receive report data associated with the first data, and optimize metadata associated with the first data based on the report data when a count of the report data exceeds a threshold.

3. The system according to claim 2, wherein the circuitry is further configured to collect the report data from a plurality of users and automatically generate corrected metadata by inputting the first data and the report data into a classification neural network configured to detect exaggerated expressions.

4. The system according to claim 1, wherein the circuitry is further configured to translate the first data from a first language to a second language by inputting the sequence of tokens into a neural machine translation model comprising an encoder-decoder architecture, and generate the waveform data in the second language.

5. The system according to claim 4, wherein the neural machine translation model is configured to analyze content of the first data using a generative AI model and perform translation and speech conversion in a single processing pipeline.

6. The system according to claim 1, wherein the circuitry is further configured to estimate an emotion of a user based on at least one of image data comprising a facial image or audio data comprising a voice waveform, and adjust an expression method of the first feature vector based on the estimated emotion.

7. The system according to claim 1, wherein the circuitry is further configured to compute an importance score for the first data based on at least one of a view count, a share count, or an impact score, and adjust a level of detail of the first feature vector based on the importance score.

8. The system according to claim 1, wherein the circuitry is further configured to classify a category of the first data by inputting the sequence of tokens into a text classification model, and apply different processing algorithms based on the classified category.

9. The system according to claim 1, wherein the circuitry is further configured to estimate an emotion of a user by inputting at least one of a facial image or a voice waveform into an emotion recognition neural network, and adjust a length of the first feature vector based on the estimated emotion by controlling an output length parameter.

10. The system according to claim 6, wherein the emotion recognition neural network comprises at least one of a convolutional neural network configured to process the facial image or a recurrent neural network configured to process the voice waveform, and outputs an emotion label and an emotion intensity score.

11. The system according to claim 1, wherein the circuitry is further configured to compute a recency score based on a timestamp associated with the first data and a current time, and determine a processing priority for the first data based on the recency score.

12. The system according to claim 1, wherein the circuitry is further configured to compute a semantic similarity score between the first data and additional data by inputting respective feature vectors into a topic modeling algorithm, and adjust a processing order based on the semantic similarity score.

13. The system according to claim 1, wherein the circuitry is further configured to estimate an emotion of a user and adjust a tone and a speed of the waveform data based on the estimated emotion by modifying parameters of the speech synthesis neural network.

14. The system according to claim 1, wherein the speech synthesis neural network comprises at least one of WaveNet or Tacotron2, and the waveform data comprises pulse code modulation data at a sampling rate of at least 16 kHz.

15. The system according to claim 1, wherein the circuitry is further configured to classify a category of the query sequence and apply different answer generation algorithms based on the classified category, wherein the different answer generation algorithms comprise a fact extraction algorithm for a first category and an emotion analysis algorithm for a second category.

16. The system according to claim 1, wherein the first neural network receives as input a token sequence of up to 4096 tokens and generates the first feature vector by extracting contextually important words and phrases using the self-attention mechanism.

17. The system according to claim 1, wherein the second neural network comprises a BERT-based encoder configured to perform semantic analysis of the query sequence and compute the semantic relevance score with the first feature vector.

18. A system comprising:
a communication interface configured to communicate with a client terminal via a packet-switched network;
a processor;
a random-access memory; and
a memory storing a first data generation model, a second data generation model, and a speech synthesis model,
wherein
the processor is configured to:
receive, via the communication interface from the client terminal, first data comprising a sequence of tokens representing text content;
generate a first feature vector by inputting the sequence of tokens into the first data generation model, the first data generation model comprising a transformer-based large language model configured to extract contextually important words and phrases using a self-attention mechanism;
receive, via the communication interface from the client terminal, a query sequence representing a natural language question;
generate a second feature vector by inputting the query sequence and the first feature vector into the second data generation model, the second data generation model comprising a BERT-based encoder configured to compute semantic relevance between the query sequence and the first feature vector;
generate waveform data by inputting at least one of the first feature vector or the second feature vector into the speech synthesis model, the speech synthesis model comprising a deep neural network configured to generate audio waveforms at a sampling rate of 16 kHz; and
transmit, via the communication interface to the client terminal, the waveform data for output by a speaker of the client terminal.

19. The system according to claim 18, wherein the processor is further configured to receive image data comprising a facial image from a camera of the client terminal, estimate an emotion of a user by inputting the facial image into an emotion recognition model comprising a convolutional neural network, and adjust at least one of a tone, a speed, or a length of the waveform data based on the estimated emotion.

20. A method performed by circuitry of a system, the method comprising:
receiving first data comprising a sequence of tokens;
generating a first feature vector by inputting the sequence of tokens into a first neural network, the first neural network comprising a transformer architecture configured to apply a self-attention mechanism to the sequence of tokens;
receiving second data comprising a query sequence;
generating a second feature vector by inputting the query sequence and the first feature vector into a second neural network configured to compute a semantic relevance score between the query sequence and the first feature vector; and
generating waveform data by inputting at least one of the first feature vector or the second feature vector into a speech synthesis neural network.
